(19) United States
(12) Patent Application Publication
(10) Pub. No.: US 2025/0197532 A1
(43) Pub. Date: Jun. 19, 2025

(54) Polysaccharide Derivatives and Compositions Comprising Same

(71) Applicant: NUTRITION & BIOSCIENCES USA 4, INC., Rochester, NY (US)

(72) Inventors: Douglas J. ADELMAN, Wilmington, DE (US); Christian Peter LENGES, Wilmington, DE (US)

(21) Appl. No.: 18/979,742

(22) Filed: Dec. 13, 2024

Related U.S. Application Data
(63) Continuation of application No. 17/413,645, filed on Jun. 14, 2021.
(60) Provisional application No. 62/780,629, filed on Dec. 17, 2018.

(51) Int. Cl. C08B 37/00; C08L 5/00

(52) U.S. Cl. CPC C08B 37/0009; C08L 5/00

(57) ABSTRACT

The disclosure relates to polysaccharide derivatives comprising a polysaccharide substituted with at least one carbamate group, wherein the polysaccharide comprises poly alpha-1,3-glucan, poly alpha-1,3-1,6-glucan, or a mixture thereof, and the polysaccharide derivative has a degree of substitution of about 0.001 to about 3 with the carbamate group. The disclosure further relates to compositions comprising the polysaccharide derivative, and to a fiber, film, coating, or article comprising the polysaccharide derivative.

### CROSS-REFERENCE TO RELATED APPLICATIONS

This application claims priority to and the benefit of U.S. provisional application No. 62/780,629, titled “Polysaccharide Derivatives and Compositions Comprising Same” filed Dec. 17, 2018, the disclosure of which is incorporated by reference herein in its entirety.

### FIELD OF THE DISCLOSURE

The present disclosure is directed to a polysaccharide derivative comprising a polysaccharide substituted with at least one carbamate group, and to compositions, films, and fibers comprising the polysaccharide derivative. The polysaccharide comprises poly alpha-1,3-glucan, poly alpha-1,3-1,6-glucan, or mixtures thereof, and the polysaccharide derivative has a degree of substitution of about 0.001 to about 3.

### BACKGROUND

Polysaccharides are an important class of polymers that have been known for many centuries. One of the most industrially important polysaccharides is cellulose. In particular, cotton, a highly pure form of naturally occurring cellulose, is well-known for its beneficial attributes in textile applications. Cellulose and starch, both based on molecular chains of polyanhydroglucose are the most abundant polymers on earth and are of great commercial importance. Such polymers offer materials that are environmentally benign throughout their entire life cycle and are constructed from renewable energy and raw materials sources.

The term “glucan” refers to a polysaccharide comprising glucose monomer units that are linked in eight possible ways. Cellulose is a glucan. Within a glucan polymer, the repeating monomeric units can be linked in a variety of configurations following an enchainment pattern. The nature of the enchainment pattern depends, in part, on how the ring closes when an aldohexose ring closes to form a hemiacetal. The open chain form of glucose (an aldohexose) has four asymmetric centers. Hence there are 24 or 16 possible open chain forms of which D and L glucose are two. When the ring is closed, a new asymmetric center is created at C1 thus making 5 asymmetric carbons. Depending on how the ring closes, for glucose, α-(1→4) linked polymer, e.g. starch, or β-(1→4) linked polymer, e.g. cellulose, can be formed upon further condensation to polymer. The configuration at C1 in the polymer determines whether it is an alpha or beta linked polymer, and the numbers in parenthesis following alpha or beta refer to the carbon atoms through which enchainment takes place.

The properties exhibited by a glucan polymer are determined by the enchainment pattern. For example, the very different properties of cellulose and starch are determined by the respective nature of their enchainment patterns. Starch contains amylose and amylopectin and is formed from alpha-(1,4) linked glucose. Starch tends to be partially water soluble and forms brittle articles. On the other hand, cellulose consists of beta-(1,4) linked glucose, and makes an excellent structural material being both crystalline and hydrophobic, and is commonly used for textile applications as cotton fiber, as well as for structures in the form of wood.

U.S. Pat. No. 7,000,000 (O'Brien) discloses a process for preparing fiber from liquid crystalline solutions of acetylated poly alpha-1,3-glucan. The thus prepared fiber was then de-acetylated resulting in a fiber of poly alpha-1,3-glucan. While certain poly alpha-1,3-glucan fibers are known, the fibers produced therefrom may not meet some end-use requirements. The fibers have high water retention which can decrease the wet strength and wet modulus, making them weaker than dry fibers. The solubility profile of poly alpha-1,3-glucan often requires the use of a salt such as lithium chloride and/or calcium chloride to increase the solubility in solvents like dimethyl acetamide. However, the addition of salt may increase the complexity of the spinning process.

There continues to be a need for polysaccharide derivatives which offer increased solubility in certain solvents and desired properties, and which can be useful in fibers, films, and other articles.

### SUMMARY

Disclosed herein is a polysaccharide derivative comprising:

a polysaccharide substituted with at least one carbamate group; wherein the polysaccharide comprises poly alpha-1,3-glucan, poly alpha-1,3-1,6-glucan, or a mixture thereof; and the polysaccharide derivative has a degree of substitution of about 0.001 to about 3.

In one embodiment, the polysaccharide comprises poly alpha-1,3-glucan, and the poly alpha-1,3-glucan comprises a backbone of glucose monomer units wherein greater than or equal to 50% of the glucose monomer units are linked via alpha-1,3-glycosidic linkages. In an additional embodiment, the polysaccharide comprises alpha-1,3-glucan, and the poly alpha-1,3-glucan comprises a backbone of glucose monomer units wherein greater than or equal to 90% of the glucose monomer units are linked via alpha-1,3-glycosidic linkages. In another embodiment, the polysaccharide comprises poly alpha-1,3-1,6-glucan, wherein (i) at least 30% of the glycosidic linkages of the poly alpha-1,3-1,6-glucan are alpha-1,3 linkages, (ii) at least 30% of the glycosidic linkages of the poly alpha-1,3-1,6-glucan are alpha-1,6 linkages, (iii) the poly alpha-1,3-1,6-glucan has a weight average degree of polymerization (DP_{w}) of at least 10; and (iv) the alpha-1,3 linkages and alpha-1,6 linkages of the poly alpha-1,3-1,6-glucan do not consecutively alternate with each other.

In one embodiment, the polysaccharide derivative has a weight average degree of polymerization in the range of from about 5 to about 1400.

In one embodiment, at least one carbamate group of the polysaccharide derivative is derived from an aliphatic, cycloaliphatic, or aromatic monoisocyanate. In one embodiment, the at least one carbamate group is a phenyl carbamate group.

Also disclosed herein is a composition comprising a polysaccharide derivative, the polysaccharide derivative comprising a polysaccharide substituted with at least one carbamate group, wherein the polysaccharide comprises poly alpha-1,3-glucan, poly alpha-1,3-1,6-glucan, or a mixture thereof; and the polysaccharide derivative has a degree of substitution of about 0.001 to about 3. In one embodiment, the composition further comprises a solvent. In one embodiment, the solvent comprises dimethyl sulfoxide, dimethyl acetamide, dimethyl formamide, pyridine, 1-methyl-2-pyrrolidinone, or a combination thereof. In one embodiment, the solvent comprises dimethyl sulfoxide. In another embodiment, the solvent comprises dimethyl acetamide. In a further embodiment, the solvent comprises dimethyl formamide.

In one embodiment, a composition comprising the polysaccharide derivative further comprises at least one polymer. In one embodiment, the at least one polymer comprises polyacrylate, polyaramid, polyphenylene isophthalamide, poly-m-phenylene isophthalamide, polyphenylene terephthalamide, vinyl polymer, polyethylene, polypropylene, poly(vinyl chloride), polystyrene, polytetrafluoroethylene, poly(alpha-methylstyrene), poly(acrylic acid), poly(isobutylene), poly(methacrylic acid), poly(methyl methacrylate), poly(1-pentene), poly(1,3-butadiene), poly(vinyl acetate), poly(2-vinyl pyridine), 1,4-polyisoprene, 3,4-polychloroprene, polyether, poly(ethylene oxide), poly(propylene oxide), poly(trimethylene glycol), poly(tetramethylene glycol), polyacetal, polyformaldehyde, polyacetaldehyde, polyesters, poly(3-propionate), poly(10-decanoate), poly(ethylene terephthalate), poly(m-phenylene terephthalate); polyamide, polycaprolactam, poly(11-undecanoamide), poly(hexamethylene sebacamide), poly(tetramethylene-m-benzenesulfonamide), polyetheretherketone, polyetherimide, poly(phenylene oxide), polyamideimide, polyarylate, polybenzimidazole, polycarbonate, polyurethane, polyimide, polyhydrazide, phenolic resin, polysilane, polysiloxane, polycarbodiimide, polyimine, azo polymer, polysulfide, polysulfane, cellulose polymers, starch polymers, or combinations thereof. Also disclosed herein is a fiber, film, or coating comprising a polysaccharide derivative as disclosed herein, as well as an article comprising such fiber, film, or coating. Additionally disclosed herein is an article comprising a polysaccharide derivative as disclosed herein. In one embodiment, the article is yarn, a fabric, a garment, apparel, a textile, carpet, packaging, or a label.

### DETAILED DESCRIPTION

All patents, patent applications, and publications cited herein are incorporated herein by reference in their entirety.

As used herein, the term “embodiment” or “disclosure” is not meant to be limiting, but applies generally to any of the embodiments defined in the claims or described herein. These terms are used interchangeably herein.

In this disclosure, a number of terms and abbreviations are used. The following definitions apply unless specifically stated otherwise.

The articles “a”, “an”, and “the” preceding an element or component are intended to be nonrestrictive regarding the number of instances (i.e. occurrences) of the element or component. There “a”, “an”, and “the” should be read to include one or at least one, and the singular word form of the element or component also includes the plural unless the number is obviously meant to be singular.

The term “comprising” means the presence of the stated features, integers, steps, or components as referred to in the claims, but that it does not preclude the presence or addition of one or more other features, integers, steps, components, or groups thereof. The term “comprising” is intended to include embodiments encompassed by the terms “consisting essentially of” and “consisting of”. Similarly, the term “consisting essentially of” is intended to include embodiments encompassed by the term “consisting of”.

Where present, all ranges are inclusive and combinable. For example, when a range of “1 to 5” is recited, the recited range should be construed as including ranges “1 to 4”, “1 to 3”, “1-2”, “1-2 and 4-5”, “1-3 and 5”, and the like.

As used herein in connection with a numerical value, the term “about” refers to a range of +/−0.5 of the numerical value, unless the term is otherwise specifically defined in context. For instance, the phrase a “pH value of about 6” refers to pH values of from 5.5 to 6.5, unless the pH value is specifically defined otherwise.

It is intended that every maximum numerical limitation given throughout this Specification includes every lower numerical limitation, as if such lower numerical limitations were expressly written herein. Every minimum numerical limitation given throughout this Specification will include every higher numerical limitation, as if such higher numerical limitations were expressly written herein. Every numerical range given throughout this Specification will include every narrower numerical range that falls within such broader numerical range, as if such narrower numerical ranges were all expressly written herein.

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

As used herein:

The term “polysaccharide” means a polymeric carbohydrate molecule composed of long chains of monosaccharide units bound together by glycosidic linkages and on hydrolysis give the constituent monosaccharides or oligosaccharides.

As used herein, the term “aryl” means an aromatic carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl groups.

As used herein, the term “aliphatic” means a linear or branched hydrocarbon group, optionally substituted with alkyl groups or alkyl groups containing one or more heteroatoms, such as O, S, or N. Aliphatic groups may be saturated or unsaturated.

The terms “percent by volume”, “volume percent”, “vol %” and “v/v %” are used interchangeably herein. The percent by volume of a solute in a solution can be determined using the formula: [(volume of solute)/(volume of solution)]×100%.

The terms “percent by weight”, “weight percentage (wt %)” and “weight-weight percentage (% w/w)” are used interchangeably herein. Percent by weight refers to the percentage of a material on a mass basis as it is comprised in a composition, mixture or solution.

The “molecular weight” of a polysaccharide or polysaccharide derivative can be represented as number-average molecular weight (Mₙ) or as weight-average molecular weight (M_{w}). Alternatively, molecular weight can be represented as Daltons, grams/mole, DPw (weight average degree of polymerization), or DPn (number average degree of polymerization). Various means are known in the art for calculating these molecular weight measurements, such as high-pressure liquid chromatography (HPLC), size exclusion chromatography (SEC), or gel permeation chromatography (GPC).

As used herein, “weight average molecular weight” or “M_{w}” is calculated as M_{w}=ΣNᵢMᵢ²/ΣNᵢMᵢ; where Mᵢ is the molecular weight of a chain and Nᵢ is the number of chains of that molecular weight. The weight average molecular weight can be determined by technics such as static light scattering, gas chromatography (GC), high pressure liquid chromatography (HPLC), gel permeation chromatography (GPC), small angle neutron scattering, X-ray scattering, and sedimentation velocity.

As used herein, “number average molecular weight” or “Mₙ” refers to the statistical average molecular weight of all the polymer chains in a sample. The number average molecular weight is calculated as Mₙ=ΣNᵢMᵢ/ ΣNᵢ where Mᵢ is the molecular weight of a chain and Nᵢ is the number of chains of that molecular weight. The number average molecular weight of a polymer can be determined by technics such as gel permeation chromatography, viscometry via the (Mark-Houwink equation), and colligative methods such as vapor pressure osmometry, end-group determination or proton NMR.

Glucose carbon positions 1, 2, 3, 4, 5 and 6 as referred to herein are as known in the art and depicted in Structure I:

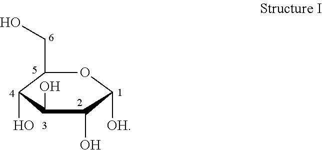

The terms “glycosidic linkage” and “glycosidic bond” are used interchangeably herein and refer to the type of covalent bond that joins a carbohydrate (sugar) molecule to another group such as another carbohydrate. The term “alpha-1,3-glucosidic linkage” as used herein refers to the covalent bond that joins alpha-D-glucose molecules to each other through carbons 1 and 3 on adjacent alpha-D-glucose rings. The term “alpha-1,2-glucosidic linkage” as used herein refers to the covalent bond that joins alpha-D-glucose molecules to each other through carbons 1 and 2 on adjacent alpha-D-glucose rings. The term “alpha-1,4-glucosidic linkage” as used herein refers to the covalent bond that joins alpha-D-glucose molecules to each other through carbons 1 and 4 on adjacent alpha-D-glucose rings. The term “alpha-1,6-glucosidic linkage” as used herein refers to the covalent bond that joins alpha-D-glucose molecules to each other through carbons 1 and 6 on adjacent alpha-D-glucose rings. Herein, “alpha-D-glucose” will be referred to as “glucose”.

The glycosidic linkage profile of a glucan or substituted glucan can be determined using any method known in the art. For example, a linkage profile can be determined using methods that use nuclear magnetic resonance (NMR) spectroscopy (e.g., ¹³C NMR or ¹H NMR). These and other methods that can be used are disclosed in Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

The structure, molecular weight, and degree of substitution of a polysaccharide or polysaccharide derivative can be confirmed using various physiochemical analyses known in the art such as NMR spectroscopy and size exclusion chromatography (SEC).

The term “polysaccharide derivative” as used herein refers to a polysaccharide such as poly alpha-1,3-glucan which has been chemically derivatized at one or more glucose carbon positions such that the original hydroxyl group at that position has been converted to another chemical group, for example a carbamate group.

The term “film” as used herein refers to a thin, visually continuous, free-standing material.

The term “packaging film” as used herein refers to a thin, visually continuous material partially or completely encompassing an object.

The term “coating” as used herein refers to a deposit of a polysaccharide derivative as disclosed herein on the surface of a material subject to a coating method. A coating can have a uniform thickness, and can have low permeability, or can be impermeable, to certain compositions (for example, liquids).

The term “uniform thickness” as used herein to characterize a film or coating can refer to a contiguous area that is at least 20% of the total film or coating area, and has a standard deviation of thickness of less than about 50 nm, for example.

A film or coating herein can be characterized as being of “low permeability” to a particular substance if the film/coating permeability to the substance is below a threshold value commonly assigned in the art of interest. To illustrate, the threshold value for styrene permeability in the SMC (super-multicoated) release film field is 200×10⁻⁹ g cm/cm^{2/}h, such as measured using the method described in American Institute of Chemical Engineer, 53rd National Meeting, Preprint No.32d (Bixler and Michaels, 1964). A film or coating can be characterized as being “impermeable” to a particular substance if it does not permit passage of the substance over an extended period of time (e.g., one or more days).

The term “fabric”, as used herein, refers to a multilayer construction of fibers or yarns.

The term “fiber” as used herein refers to an elongate body the length dimension of which is much greater than the transverse dimensions of width and thickness. Accordingly, the term fiber includes monofilament fiber, multifilament fiber, ribbon, strip, a plurality of any one or combinations thereof and the like having regular or irregular cross-section.

The term “yarn” as used herein refers to a continuous strand of fibers.

The term “textile” as used herein refers to garments and other articles fabricated from fibers, yarns, or fabrics when the products retain the characteristic flexibility and drape of the original fabrics.

The present disclosure is directed to a polysaccharide derivative comprising a polysaccharide substituted with at least one carbamate group, and to compositions, films, fibers, and coatings comprising the polysaccharide derivative. With an appropriate molecular weight and a sufficiently high degree of substitution, the polysaccharide derivative can be soluble in solvents such as dimethyl acetamide or dimethyl formamide, which enables the use of the derivative alone or in combination with other polymers as a blend, in various applications such as forming films, coating substrates, and spinning fibers. Additionally, the polysaccharide derivative can be used as a rheology modifier, as a water absorbent, or as a moisture management component of a composite or blend.

The polysaccharide derivative comprises a polysaccharide substituted with at least one carbamate group, wherein the polysaccharide comprises poly alpha-1,3-glucan, poly alpha-1,3-1,6-glucan, or a mixture thereof. The carbamate group —O—C(═O)—NH—R is linked to the polysaccharide by derivatization of a hydroxyl group, whereby a —OH group of the polysaccharide is replaced by the —O—C(═O)—NH—R group. The carbamate group is derived from reaction of a monoisocyanate with the polysaccharide. The R group within the carbamate substituent can be an aryl group, an aliphatic group, or a cycloaliphatic group.

In one embodiment, the R group is an aryl group, for example a phenyl, benzyl, diphenyl methyl, or diphenyl ethyl group. At least one carbamate group of the polysaccharide derivative can be derived from an aromatic monoisocyanate, for example phenyl, benzyl, diphenyl methyl, or diphenyl ethyl isocyanate. In one embodiment, at least one carbamate group of the polysaccharide derivative is phenylcarbamate. In another embodiment, the R group is an aliphatic group, for example an ethyl, propyl, butyl, tert-butyl, pentyl, hexyl, heptyl, octyl, nonyl, decyl, undecyl, or octadecyl group. At least one carbamate group of the polysaccharide derivative can be derived from an aliphatic monoisocyanate, for example ethyl, propyl, butyl, tert-butyl, pentyl, hexyl, heptyl, octyl, nonyl, decyl, undecyl, or octadecyl isocyanate. In a further embodiment, the R group is a cycloaliphatic group, for example a cyclohexyl, cycloheptyl, or cyclododecyl group. At least one carbamate group of the polysaccharide derivative can be derived from a cycloaliphatic monoisocyanate, for example cyclohexyl, cycloheptyl, or cyclododecyl isocyanate. Useful monoisocyanates are commercially available.

In one embodiment, the polysaccharide derivative comprises poly alpha-1,3-glucan substituted with one carbamate group. In another embodiment, the polysaccharide derivative comprises poly alpha-1,3-glucan substituted with two or more carbamate groups, wherein the two carbamate groups are not the same. In an additional embodiment, the polysaccharide derivative comprises poly alpha-1,3-glucan substituted with at least one carbamate group derived from an aromatic monoisocyanate. In a further embodiment, the polysaccharide derivative comprises poly alpha-1,3-glucan substituted with at least one carbamate group derived from an aliphatic monoisocyanate. In yet another embodiment, the polysaccharide derivative comprises poly alpha-1,3-glucan substituted with at least one carbamate group derived from a cycloaliphatic monoisocyanate. In one embodiment, the polysaccharide derivative comprises poly alpha-1,3-glucan substituted with at least one phenyl carbamate group.

In one embodiment, the polysaccharide derivative comprises poly alpha-1,3-1,6-glucan substituted with one carbamate group. In another embodiment, the polysaccharide derivative comprises poly alpha-1,3-1,6-glucan substituted with two or more carbamate groups, wherein the two carbamate groups are not the same. In one embodiment, the polysaccharide derivative comprises poly alpha-1,3-1,6-glucan substituted with at least one phenyl carbamate group. In an additional embodiment, the polysaccharide derivative comprises poly alpha-1,3-1,6-glucan substituted with at least one carbamate group derived from an aromatic monoisocyanate. In a further embodiment, the polysaccharide derivative comprises poly alpha-1,3-1,6-glucan substituted with at least one carbamate group derived from an aliphatic monoisocyanate. In yet another embodiment, the polysaccharide derivative comprises poly alpha-1,3-1,6-glucan substituted with at least one carbamate group derived from a cycloaliphatic monoisocyanate.

The polysaccharide derivative has a degree of substitution of about 0.001 to about 3. The term “degree of substitution” (DOS) as used herein refers to the average number of hydroxyl groups substituted in each monomeric unit (glucose) of a poly alpha-1,3-glucan derivative. Since there are at most three hydroxyl groups in a glucose monomeric unit in a poly alpha-1,3-glucan polymer or derivative, the overall degree of substitution can be no higher than 3. It would be understood by those skilled in the art that, since a polysaccharide derivative as disclosed herein can have a degree of substitution between about 0.001 to about 3.0, the substituents on the polysaccharide cannot only be hydrogen. The target DoS can be chosen to provide the desired solubility and performance of the polysaccharide derivative in the specific application of interest. In one embodiment, the polysaccharide derivative has a DoS in the range of about 0.001 to about 3.0, for example of about 0.05 to about 3, or for example of about 0.001 to about 0.4. In another embodiment, the polysaccharide derivative has a DoS of at least 0.4, for example in the range of about 0.4 to about 1.5, or about 0.4 to about 2, or about 0.4 to about 3. Alternatively, the DoS can be about 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, or any value between 0.001 and 3. The target DoS is chosen to provide the desired solubility and performance of the polysaccharide derivative for the specific application of interest. A DoS of at least 0.4 can be necessary for solubility of the polysaccharide derivative in certain solvents, for example dimethyl acetamide and dimethyl formamide.

When the polysaccharide derivative comprises a polysaccharide substituted with two different carbamates, the degree of substitution of the polysaccharide derivative can be stated with reference to the first carbamate group, with reference to the second carbamate group, or with reference to the overall degree of substitution, that is, the sum of the DoS of the first and second carbamate groups. As used herein, when the degree of substitution is not stated with reference to the first or second carbamate group, the overall degree of substitution is meant. When two carbamate groups are present, the DoS with reference to the first carbamate group alone, or with reference to the second carbamate group alone, is necessarily less than 3.

In one embodiment, the polysaccharide derivative comprises poly alpha-1,3-glucan substituted with at least one carbamate group, and the polysaccharide derivative has a degree of substitution of about 0.001 to about 0.4. In another embodiment, the polysaccharide derivative comprises poly alpha-1,3-glucan substituted with at least one carbamate group, and the polysaccharide derivative has a degree of substitution of about 0.4 to about 1.5. In a further embodiment, the polysaccharide derivative comprises poly alpha-1,3-glucan substituted with at least one carbamate group, and the polysaccharide derivative has a degree of substitution of about 0.4 to about 2. In yet another embodiment, the polysaccharide derivative comprises poly alpha-1,3-glucan substituted with at least one carbamate group, and the polysaccharide derivative has a degree of substitution of about 0.4 to about 3.

In one embodiment, the polysaccharide is poly alpha-1,3-glucan. Poly alpha-1,3-glucan means a polymer comprising glucose monomeric units linked together by glycosidic linkages, wherein at least about 50% of the glycosidic linkages are alpha-1,3-glycosidic linkages. Poly alpha-1,3-glucan is a type of polysaccharide. The alpha-1,3-glycosodic linkage of the poly alpha-1,3-glucan can be illustrated by Structure Il as follows:

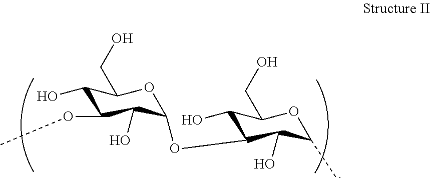

The poly alpha-1,3-glucan can be prepared using chemical methods. Alternatively, it can be prepared by extracting it from various organisms, such as fungi, that produce poly alpha-1,3-glucan. Alternatively, poly alpha-1,3-glucan can be enzymatically produced from sucrose using one or more glucosyltransferase (gtf) enzymes (e.g., gtfJ), such as described in U.S. Pat. Nos. 7,000,000; 8,642,757; and 9,080,195 (the entirety of which are incorporated herein by reference), for example. Using the procedures given therein, the polymer is made directly in a one-step enzymatic reaction using a recombinant glucosyltransferase enzyme, for example the gtfJ enzyme, as the catalyst and sucrose as the substrate. The poly alpha-1,3-glucan is produced with fructose as the by-product. As the reaction progresses, the poly alpha-1,3-glucan precipitates from solution. Produced using the gtfJ enzyme, the poly alpha-1,3-glucan can have a number average degree of polymerization (DPn) in the range of 4 to 500. In other embodiments, the DPn can be in the range of from 30 to 500 or from 40 to 500 or from 50 to 400. In some embodiments, the poly alpha-1,3-glucan has a DPw of from about 10 to about 400, 10 to about 300, 10 to about 200, 10 to about 100, 10 to about 50, 400 to about 1400, or from about 400 to about 1000, or from about 500 to about 900.

Glucosyltransferases contemplated to be useful for producing insoluble alpha-1,3-glucan herein are disclosed in US Patent Nos. 7,000,000, 8,871,474, 10,301,604 and 10,260,053, US Patent Application Publication Nos. 2019/0078062, 2019/0078063, and 2017/0002335, and U.S. patent application Ser. No. 16/295,423 (as originally filed), for example, all of which are incorporated herein by reference. Alpha-1,3-glucan in some embodiments can be as disclosed in any of the foregoing references, as well as in any of US Patent Application Publication Nos. 2019/0185893 and 2018/0340199, and International Patent Application Publication No. WO 2017/079595, all of which are incorporated herein by reference.

In some embodiments, the percentage of glycosidic linkages between the glucose monomer units of the poly alpha-1,3-glucan that are alpha-1,3 is greater than or equal to 50%, 60%, 70%, 80%, 90%, 95%, 96%, 97%, 98%, 99%, or 100% (or any integer value between 50% and 100%). In such embodiments, accordingly, poly alpha-1,3-glucan has less than or equal to 50%, 40%, 30%, 20%, 10%, 5%, 4%, 3%, 2%, 1%, or 0% (or any integer value between 0% and 50%) of glycosidic linkages that are not alpha-1,3. The poly alpha-1,3-glucan may have relatively low percentages of glucose monomers that are linked at the 1,2-, 1,4- and/or 1,6-positions. In some embodiments, the poly alpha-1,3-glucan comprises greater than or equal to 93 to 97% alpha-1,3-glycosidic linkages and less than 3% alpha-1,6-glycosidic linkages. In other embodiments, the poly alpha-1,3-glucan comprises greater than or equal to 95% alpha-1,3-glycosidic linkages and about 1% alpha-1,6-glycosidic linkages.

In one embodiment, the polysaccharide is poly alpha-1,3-1,6-glucan. Poly alpha-1,3-1,6-glucan is a product of a glucosyltransferase enzyme, as disclosed in United States Patent Application Publication 2015/0232785 A1. In some embodiments, an insoluble alpha-glucan can comprise at least about 30% alpha-1,3 linkages and a percentage of alpha-1,6 linkages that brings the total of both the alpha-1,3 and-1,6 linkages in the alpha-glucan to 100%. For example, the percentage of alpha-1,3 and-1,6 linkages can be about 30-40% and 60-70%, respectively. In some aspects, an insoluble alpha-glucan comprising at least about 30% alpha-1,3 linkages is linear. Glucosyltransferases for producing insoluble alpha-glucan comprising at least about 30% alpha-1,3 linkages are disclosed in U.S. Pat. Appl. Publ. No. 2015/0232819, now U.S. Pat. No. 9,926,541, the disclosure of which is incorporated herein by reference in its entirety.

In one embodiment, the polysaccharide comprises poly alpha-1,3-1,6-glucan wherein (i) at least 30% of the glycosidic linkages of the poly alpha-1,3-1,6-glucan are alpha-1,3 linkages, (ii) at least 30% of the glycosidic linkages of the poly alpha-1,3-1,6-glucan are alpha-1,6 linkages, (iii) the poly alpha-1,3-1,6-glucan has a weight average degree of polymerization (DP_{w}) of at least 10; and (iv) the alpha-1,3 linkages and alpha-1,6 linkages of the poly alpha-1,3-1,6-glucan do not consecutively alternate with each other. In another embodiment, at least 60% of the glycosidic linkages of the poly alpha-1,3-1,6-glucan are alpha-1,6 linkages.

At least 30% of the glycosidic linkages of poly alpha-1,3-1,6-glucan are alpha-1,3 linkages, and at least 30% of the glycosidic linkages of the poly alpha-1,3-1,6-glucan are alpha-1,6 linkages. Alternatively, the percentage of alpha-1,3 linkages in poly alpha-1,3-1,6-glucan herein can be at least 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, or 64%. Alternatively still, the percentage of alpha-1,6 linkages in poly alpha-1,3-1,6-glucan herein can be at least 31%, 32%, 33%, 34%, 35%, 36%, 37%, 38%, 39%, 40%, 41%, 42%, 43%, 44%, 45%, 46%, 47%, 48%, 49%, 50%, 51%, 52%, 53%, 54%, 55%, 56%, 57%, 58%, 59%, 60%, 61%, 62%, 63%, 64%, 65%, 66%, 67%, 68%, or 69%.

A poly alpha-1,3-1,6-glucan can have any one the aforementioned percentages of alpha-1,3 linkages and any one of the aforementioned percentages of alpha-1,6 linkages, just so long that the total of the percentages is not greater than 100%. For example, poly alpha-1,3-1,6-glucan herein can have (i) any one of 30%, 31%, 32%, 33%, 34%, 35%, 36%, 37%, 38%, 39%, or 40% (30%- 40%) alpha-1,3 linkages and (ii) any one of 60%, 61%, 62%, 63%, 64%, 65%, 66%, 67%, 68%, or 69% (60%-69%) alpha-1,6 linkages, just so long that the total of the percentages is not greater than 100%. Non-limiting examples include poly alpha-1,3-1,6-glucan with 31% alpha-1,3 linkages and 67% alpha-1,6 linkages. In certain embodiments, at least 60% of the glycosidic linkages of the poly alpha-1,3-1,6-glucan are alpha-1,6 linkages.

A poly alpha-1,3-1,6-glucan can have, for example, less than 10%, 9%, 8%, 7%, 6%, 5%, 4%, 3%, 2%, or 1% of glycosidic linkages other than alpha-1,3 and alpha-1,6. In another embodiment, a poly alpha-1,3-1,6-glucan only has alpha-1,3 and alpha-1,6 linkages.

The backbone of a poly alpha-1,3-1,6-glucan disclosed herein can be linear/unbranched. Alternatively, there can be branches in the poly alpha-1,3-1,6-glucan. A poly alpha-1,3-1,6-glucan in certain embodiments can thus have no branch points or less than about 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 3%, 2%, or 1% branch points as a percent of the glycosidic linkages in the polymer.

The alpha-1,3 linkages and alpha-1,6 linkages of a poly alpha-1,3-1,6-glucan do not consecutively alternate with each other. For the following discussion, consider that . . . G-1,3-G-1,6-G-1,3-G-1,6-G-1,3-G- . . . (where G represents glucose) represents a stretch of six glucose monomeric units linked by consecutively alternating alpha-1,3 linkages and alpha-1,6 linkages. Poly alpha-1,3-1,6-glucan in certain embodiments herein comprises less than 2, 3, 4, 5, 6, 7, 8, 9, 10, or more glucose monomeric units that are linked consecutively with alternating alpha-1,3 and alpha-1,6 linkages.

The molecular weight of a poly alpha-1,3-1,6-glucan can be measured as DP_{w} (weight average degree of polymerization) or DPₙ (number average degree of polymerization). Alternatively, molecular weight can be measured in Daltons or grams/mole. It may also be useful to refer to the number-average molecular weight (Mₙ) or weight-average molecular weight (M_{w}) of the poly alpha-1,3-1,6-glucan.

A poly alpha-1,3-1,6-glucan herein can have an Mw of at least about 1600, 3000, 4000, 5000, 8000, 10000, 15000, 20000, 25000, 30000, 35000, 40000, 50000, 100000, 200000, 300000, 400000, 500000, 600000, 700000, 800000, 900000, 1000000, 1100000, 1200000, 1300000, 1400000, 1500000, or 1600000 (or any integer between 50000 and 1600000), for example. The M_{w} in certain embodiments is at least about 1000000. Alternatively, poly alpha-1,3-1,6-glucan can have an M_{w} of at least about 1600, 3000, 4000, 5000, 10000, 20000, 30000, or 40000, for example.

A poly alpha-1,3-1,6-glucan herein can comprise at least 10 glucose monomeric units, for example. Alternatively, the number of glucose monomeric units can be at least 10, 25, 50, 100, 500, 1000, 2000, 3000, 4000, 5000, 6000, 7000, 8000, or 9000 (or any integer between 10 and 9000), for example.

Polysaccharide derivatives comprising a polysaccharide substituted with at least one carbamate group can be prepared by contacting the polysaccharide with at least one monoisocyanate in a solvent. An aprotic solvent such as dimethylsulfoxide (DMSO), dimethylformamide (DMF), or dimethylacetamide (DMAc) can be charged with calcium chloride dihydrate and polysaccharide powder to a reactor under agitation at room temperature. The solvent to calcium chloride dihydrate weight ratio can range from 10:1 to 40:1. The polysaccharide to solvent weight ratio can range from 5:1 to 30:1, for example 10:1 to 20:1. The polysaccharide is dissolved by heating the mixture to 30-80° C. and holding until clarity is achieved. Water is then removed by distilling solvent and water out. The percent of solvent distilled over to dry the system can vary from 0 to 60, depending on the desired water content in the reactor ahead of adding the monoisocyanate. Water contents of 500 to 2000 ppm can be achieved by removal of 20 to 60 percent of the solvent added. The lower the water content, the less monoisocyanate will be lost to reaction with water.

The monoisocyanate can be added at a temperature in the range of 25° C. up to the boiling temperature of the system, for example at a temperature in the range of 40 to 80° C. The molar ratio of monoisocyanate to polysaccharide can range from 0.1:1 to 4.0:1, depending on the desired final degree of substitution. After the addition of the monoisocyanate, the mixture can be held at temperature for 0.1 to 24 hours, for example 0.5 to 4 hours. The final reaction liquor can contain 2-9% calcium chloride and 0.5-30% derivatized polysaccharide, with the balance solvent. In one embodiment, the mixture will contain 3-5% calcium chloride and 5-15% derivatized polysaccharide.

The derivatized polysaccharide can be precipitated by pouring the reactor contents into agitated water, methanol, isopropanol, ethanol, acetone, or mixtures thereof in a volume to weight ratio of 2-8 liters to 1 kilogram, for example at a volume to weight ratio of 4. The precipitated polysaccharide derivative can be filtered and dried.

If desired, the polysaccharide may be ground to smaller particle size before use in a derivatization reaction. One advantage of derivatizing a polysaccharide with a monoisocyanate rather than, for example, a derivatizing agent comprising a halide, is that with a monoisocyanate no by-product hydrogen chloride is generated. As a result, molecular weight degradation of the poly alpha-1,3-glucan or poly alpha-1,3-1,6-glucan starting material is less likely. If only a portion of the polysaccharide dissolves before the monoisocyanate is added to the reaction mixture, incomplete derivatization can occur; this may be observed as swelled gels in the reaction product. Typically, a poly alpha-1,3-glucan carbamate compound having a DoS of 0.4 or greater is expected to be soluble, for example in DMAc or DMF.

Also disclosed herein are compositions comprising a polysaccharide derivative, the polysaccharide derivative comprising a polysaccharide substituted with at least one carbamate group; wherein the polysaccharide comprises poly alpha-1,3-glucan, poly alpha-1,3-1,6-glucan, or a mixture thereof, and the polysaccharide derivative has a degree of substitution of about 0.001 to about 3. In one embodiment, the composition further comprises a solvent. In one embodiment, the solvent comprises dimethyl sulfoxide, dimethyl acetamide, dimethyl formamide, pyridine, 1-methyl-2-pyrrolidinone, or a combination thereof. In one embodiment, the solvent comprises dimethyl acetamide. In another embodiment, the solvent comprises dimethyl formamide. In one embodiment, the composition further comprises a solvent, and the polysaccharide derivative is present in the composition in an amount in the range of from about 0.5 wt % to about 30 wt %, or for example from about 5 wt % to about 15 wt %.

In one embodiment, a composition comprises a polysaccharide derivative comprising poly alpha-1,3-glucan substituted with at least one carbamate group, wherein the polysaccharide derivative has a degree of substitution of about 0.001 to about 0.4, and the composition further comprises a solvent. In one embodiment, the solvent comprises dimethyl acetamide, dimethyl formamide, or a mixture thereof. In one embodiment, the at least one carbamate group is phenyl carbamate.

In another embodiment, a composition comprises a polysaccharide derivative comprising poly alpha-1,3-glucan substituted with at least one carbamate group, wherein the polysaccharide derivative has a degree of substitution of about 0.4 to about 1.5, and the composition further comprises a solvent. In one embodiment, the solvent comprises dimethyl acetamide, dimethyl formamide, or a mixture thereof. In one embodiment, the at least one carbamate group is phenyl carbamate.

In a further embodiment, a composition comprises a polysaccharide derivative comprising poly alpha-1,3-glucan substituted with at least one carbamate group, wherein the polysaccharide derivative has a degree of substitution of about 0.4 to about 2, and the composition further comprises a solvent. In one embodiment, the solvent comprises dimethyl acetamide, dimethyl formamide, or a mixture thereof. In one embodiment, the at least one carbamate group is phenyl carbamate.

In yet another embodiment, a composition comprises a polysaccharide derivative comprising poly alpha-1,3-glucan substituted with at least one carbamate group, wherein the polysaccharide derivative has a degree of substitution of about 0.4 to about 3, and the composition further comprises a solvent. In one embodiment, the solvent comprises dimethyl acetamide, dimethyl formamide, or a mixture thereof. In one embodiment, the at least one carbamate group is phenyl carbamate.

Compositions comprising a polysaccharide derivative as disclosed herein can be used in applications for films, coatings, adhesives, dispersion, rheology modifiers, foams, water absorbents, formed objects, or fibers. In one embodiment, a composition comprising the polysaccharide derivative can be used as a water retention value modifier. In another embodiment, a composition comprising the polysaccharide derivative can be used as a compatibilizer.

The polysaccharide derivatives disclosed herein can be comprised in a personal care product, pharmaceutical product, household product, or industrial product in an amount that provides a desired degree of one or more of the following physical properties to the product: thickening, freeze/thaw stability, lubricity, moisture retention and release, texture, consistency, shape retention, emulsification, binding, suspension, dispersion, and gelation, for example. Examples of a concentration or amount of a polysaccharide derivative as disclosed herein in a product, on a weight basis, can be about 0.1-3 wt %, 1-2 wt %, 1.5-2.5 wt %, 2.0 wt %, 0.1-4 wt %, 0.1-5 wt %, or 0.1-10 wt %, for example.

A household and/or industrial product herein can be in the form of drywall tape-joint compounds; mortars; grouts; cement plasters; spray plasters; cement stucco; adhesives; pastes; wall/ceiling texturizers; binders and processing aids for tape casting, extrusion forming, injection molding and ceramics; spray adherents and suspending/dispersing aids for pesticides, herbicides, and fertilizers; hard surface cleaners; air fresheners; polymer emulsions; gels such as water-based gels; surfactant solutions; paints such as water-based paints; protective coatings; adhesives; sealants and caulks; inks such as water-based ink; metal-working fluids; emulsion-based metal cleaning fluids used in electroplating, phosphatizing, galvanizing and/or general metal cleaning operations; hydraulic fluids (e.g., those used for fracking in downhole operations); and aqueous mineral slurries, for example.

A composition comprising a polysaccharide derivative as disclosed herein can be non-aqueous (e.g., a dry composition). Examples of such embodiments include films, coatings, powders, granules, microcapsules, flakes, or any other form of particulate matter. Other examples include larger compositions such as pellets, bars, kernels, beads, tablets, sticks, or other agglomerates. A non-aqueous or dry composition herein can typically has less than 3, 2, 1, 0.5, or 0.1 wt % water comprised therein. The amount of polysaccharide derivative in a non-aqueous or dry composition can be about, or at least about, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, 99.5, or 99.9 wt %, for example. A non-aqueous composition herein can be in the form of a household product, personal care product, pharmaceutical product, or industrial product, for example.

Depending upon the desired application, a polysaccharide derivative as disclosed herein can be formulated, for example, blended, mixed, or incorporated into, with one or more other materials and/or active ingredients suitable for use in various compositions, for example compositions for use in industrial, laundry care, textile/fabric care, and/or personal care products. The term “composition comprising a polysaccharide derivative” in this context may include, for example, industrial products, aqueous formulations, rheology modifying compositions, fabric treatment/care compositions, laundry care formulations/compositions, fabric softeners or personal care compositions (hair, skin and oral care), each comprising a polysaccharide derivative as disclosed herein.

As used herein, the term “effective amount” refers to the amount of the substance used or administered that is suitable to achieve the desired effect. The effective amount of material may vary depending upon the application. One of skill in the art will typically be able to determine an effective amount for a particular application or subject without undo experimentation.

The term “resistance to enzymatic hydrolysis” refers to the relative stability of the polysaccharide derivative to enzymatic hydrolysis. Having a resistance to hydrolysis is important for the use of these materials in applications wherein enzymes are present, such as in detergent, fabric care, and/or laundry care applications. In some embodiments, a polysaccharide derivative is resistant to cellulases. In other embodiments, a polysaccharide derivative is resistant to proteases. In still further embodiments, a polysaccharide derivative is resistant to amylases. In yet other embodiments, the polysaccharide derivative is resistant to lipases. In yet other embodiments, a polysaccharide derivative is resistant to mannanases. In other embodiments, a polysaccharide derivative is resistant to multiple classes of enzymes, for example, two or more cellulases, proteases, amylases, lipases, mannanases, or combinations thereof. Resistance to any particular enzyme will be defined as having at least 10, 20, 30, 40, 50, 60, 70, 80, 90, 95 or 100% of the materials remaining after treatment with the respective enzyme. The percentage remaining may be determined by measuring the supernatant after enzyme treatment using SEC-HPLC. The assay to measure enzyme resistance can be determined using the following procedure: A sample of the polysaccharide derivative is added to water in a vial and mixed using a PTFE magnetic stir bar to create a 1 percent by weight aqueous solution. The aqueous mixture is produced at pH 7.0 and 20° C. After the polysaccharide derivative thereof has completely dissolved, 1.0 milliliter (mL) (1 percent by weight of the enzyme formulation) of cellulase (PURADEX® EGL), amylase (PURASTAR® ST L) protease (SAVINASE® 16.0 L), or lipase (Lipex® 100 L) is added and mixed for 72 hours (hrs) at 20° C. After 72 hrs of stirring, the reaction mixture is heated to 70° C. for 10 minutes to inactivate the added enzyme, and the resulting mixture is cooled to room temperature and centrifuged to remove any precipitate. The supernatant is analyzed by SEC-HPLC for recovered polysaccharide derivative and compared to a control where no enzyme was added to the reaction mixture. Percent changes in area counts for the respective polysaccharide derivative thereof may be used to test the relative resistance of the materials to the respective enzyme treatment. Percent changes in area versus the total will be used to assess the relative amount of materials remaining after treatment with a particular enzyme. Materials having a percent recovery of at least 10%, preferably at least 50, 60, 70, 80, 90, 95 or 100% will be considered “resistant” to the respective enzyme treatment.

The phrase “aqueous composition” herein refers to a solution or mixture in which the solvent is at least about 1% by weight of water and which comprises a polysaccharide derivative. The terms “hydrocolloid” and “hydrogel” are used interchangeably herein. A hydrocolloid refers to a colloid system in which water is the dispersion medium. A “colloid” herein refers to a substance that is microscopically dispersed throughout another substance. Therefore, a hydrocolloid herein can also refer to a dispersion, emulsion, mixture, or solution of a polysaccharide derivative in water or aqueous solution.

The term “aqueous solution” herein refers to a solution in which the solvent is water. A polysaccharide derivative can be dispersed, mixed, and/or dissolved in an aqueous solution. An aqueous solution can serve as the dispersion medium of a hydrocolloid herein.

The terms “dispersant” and “dispersion agent” are used interchangeably herein to refer to a material that promotes the formation and stabilization of a dispersion of one substance in another. A “dispersion” herein refers to an aqueous composition comprising one or more particles, for example, any ingredient of a personal care product, pharmaceutical product, food product, household product or industrial product that are scattered, or uniformly distributed, throughout the aqueous composition. It is believed that a polysaccharide derivative can act as dispersants in aqueous compositions disclosed herein.

The term “viscosity” as used herein refers to the measure of the extent to which a fluid or an aqueous composition such as a hydrocolloid resists a force tending to cause it to flow. Various units of viscosity that can be used herein include centipoise (cPs) and Pascal-second (Pa·s). A centipoise is one one-hundredth of a poise; one poise is equal to 0.100 kg·m⁻¹·s⁻¹. Thus, the terms “viscosity modifier” and “viscosity-modifying agent” as used herein refer to anything that can alter/modify the viscosity of a fluid or aqueous composition.

The terms “fabric”, “textile”, and “cloth” are used interchangeably herein to refer to a woven or non-woven material having a network of natural and/or artificial fibers. Such fibers can be thread or yarn, for example.

A “fabric care composition” herein is any composition suitable for treating fabric in some manner. Suitable examples of such a composition include non-laundering fiber treatments (for desizing, scouring, mercerizing, bleaching, coloration, dying, printing, bio-polishing, anti-microbial treatments, anti-wrinkle treatments, stain resistance treatments, etc.), laundry care compositions (e.g., laundry care detergents), and fabric softeners.

The terms “detergent composition”, “heavy duty detergent” and “all-purpose detergent” are used interchangeably herein to refer to a composition useful for regular washing of a substrate, for example, dishware, cutlery, vehicles, fabrics, carpets, apparel, white and colored textiles at any temperature. Detergent compositions for treating of fabrics, hard surfaces and any other surfaces in the area of fabric and home care, include: laundry detergents, fabric conditioners (including softeners), laundry and rinse additives and care compositions, fabric freshening compositions, laundry prewash, laundry pretreat, hard surface treatment compositions, car care compositions, dishwashing compositions (including hand dishwashing and automatic dishwashing products), air care products, detergent contained on or in a porous substrate or nonwoven sheet, and other cleaner products for consumer or institutional use

The terms “cellulase” and “cellulase enzyme” are used interchangeably herein to refer to an enzyme that hydrolyzes β-1,4-D-glucosidic linkages in cellulose, thereby partially or completely degrading cellulose. Cellulase can alternatively be referred to as “β-1,4-glucanase”, for example, and can have endocellulase activity (EC 3.2.1.4), exocellulase activity (EC 3.2.1.91), or cellobiase activity (EC 3.2.1.21). A cellulase in certain embodiments herein can also hydrolyze β-1,4-D-glucosidic linkages in cellulose ether derivatives such as carboxymethyl cellulose. “Cellulose” refers to an insoluble polysaccharide having a linear chain of β-1,4-linked D-glucose monomeric units.

As used herein, the term “fabric hand” or “handle” is meant people's tactile sensory response towards fabric which may be physical, physiological, psychological, social or any combination thereof. In some embodiments, the fabric hand may be measured using a PHABROMETER® System (available from Nu Cybertek, Inc. Davis, California) for measuring the relative hand value as given by the American Association of Textile Chemists and Colorists (AATCC test method “202-2012, Relative Hand Value of Textiles: Instrumental Method”).

The composition can be in the form of a liquid, a gel, a powder, a hydrocolloid, an aqueous solution, a granule, a tablet, a capsule, a single compartment sachet, a multi-compartment sachet, a single compartment pouch, or a multi-compartment pouch. In some embodiments, the composition is in the form of a liquid, a gel, a powder, a single compartment sachet, or a multi-compartment sachet.

In some embodiments, compositions comprising a polysaccharide derivative as disclosed herein can be in the form of a fabric care composition. A fabric care composition can be used for hand wash, machine wash and/or other purposes such as soaking and/or pretreatment of fabrics, for example. A fabric care composition may take the form of, for example, a laundry detergent; fabric conditioner; any wash-, rinse-, or dryer-added product; unit dose or spray. Fabric care compositions in a liquid form may be in the form of an aqueous composition. In other embodiments, a fabric care composition can be in a dry form such as a granular detergent or dryer-added fabric softener sheet. Other non-limiting examples of fabric care compositions can include: granular or powder-form all-purpose or heavy-duty washing agents; liquid, gel or paste-form all-purpose or heavy-duty washing agents; liquid or dry fine-fabric (e.g.

delicates) detergents; cleaning auxiliaries such as bleach additives, “stain-stick”, or pre-treatments; substrate-laden products such as dry and wetted wipes, pads, or sponges; sprays and mists; water-soluble unit dose articles.

In some embodiments, compositions comprising a polysaccharide derivative can be in the form of a personal care product. Personal care products include, but are not limited to, hair care compositions, skin care compositions, sun care compositions, body cleanser compositions, oral care compositions, wipes, beauty care compositions, cosmetic compositions, antifungal compositions, and antibacterial compositions. The personal care products can include cleansing, cleaning, protecting, depositing, moisturizing, conditioning, occlusive barrier, and emollient compositions.

As used herein, “personal care products” also includes products used in the cleaning, bleaching and/or disinfecting of hair, skin, scalp, and teeth, including, but not limited to shampoos, body lotions, shower gels, topical moisturizers, toothpaste, toothgels, mouthwashes, mouthrinses, anti-plaque rinses, and/or other topical cleansers. In some embodiments, these products are utilized on humans, while in other embodiments, these products find use with non-human animals (e.g., in veterinary applications). In one aspect, “personal care products” includes hair care products. The hair care product can be in the form of a powder, paste, gel, liquid, oil, ointment, spray, foam, tablet, a hair shampoo, a hair conditioner rinse or any combination thereof.

The product formulation comprising a polysaccharide derivative described herein may be optionally diluted with water, or a solution predominantly comprised of water, to produce a formulation with the desired polysaccharide derivative concentration for the target application. Clearly one of skill in the art can adjust the reaction components and/or dilution amounts to achieve the desired polysaccharide derivative concentration for the chosen personal care product.

The personal care compositions described herein may further comprise one or more dermatologically or cosmetically acceptable components known or otherwise effective for use in hair care or other personal care products, provided that the optional components are physically and chemically compatible with the essential components described herein, or do not otherwise unduly impair product stability, aesthetics, or performance. Non-limiting examples of such optional components are disclosed in International Cosmetic Ingredient Dictionary, Ninth Edition, 2002, and CTFA Cosmetic Ingredient Handbook, Tenth Edition, 2004.

In one embodiment, the dermatologically acceptable carrier may comprise from about 10 wt % to about 99.9 wt %, alternatively from about 50 wt % to about 95 wt %, and alternatively from about 75 wt % to about 95 wt %, of a dermatologically acceptable carrier. Carriers suitable for use with the composition(s) may include, for example, those used in the formulation of hair sprays, mousses, tonics, gels, skin moisturizers, lotions, and leave-on conditioners. The carrier may comprise water; organic oils; silicones such as volatile silicones, amino or non-amino silicone gums or oils, and mixtures thereof; mineral oils; plant oils such as olive oil, castor oil, rapeseed oil, coconut oil, wheatgerm oil, sweet almond oil, avocado oil, macadamia oil, apricot oil, safflower oil, candlenut oil, false flax oil, tamanu oil, lemon oil and mixtures thereof; waxes; and organic compounds such as C₂-C₁₀ alkanes, acetone, methyl ethyl ketone, volatile organic C₁-C₁₂ alcohols, esters (with the understanding that the choice of ester(s) may be dependent on whether or not it may act as a carboxylic acid ester substrates for the perhydrolases) of C₁-C₂₀ acids and of C₁-C₈ alcohols such as methyl acetate, butyl acetate, ethyl acetate, and isopropyl myristate, dimethoxyethane, diethoxyethane, C₁₀-C₃₀ fatty alcohols such as lauryl alcohol, cetyl alcohol, stearyl alcohol, and behenyl alcohol; C10-C₃₀ fatty acids such as lauric acid and stearic acid; C₁₀-C₃₀ fatty amides such as lauric diethanolamide; C₁₀-C₃₀ fatty alkyl esters such as C₁₀-C₃₀ fatty alkyl benzoates; hydroxypropylcellulose, and mixtures thereof. In one embodiment, the carrier comprises water, fatty alcohols, volatile organic alcohols, and mixtures thereof.

The composition(s) disclosed herein further may comprise from about 0.1% to about 10%, and alternatively from about 0.2% to about 5.0%, of a gelling agent to help provide the desired viscosity to the composition(s). Non-limiting examples of suitable optional gelling agents include crosslinked carboxylic acid polymers; unneutralized crosslinked carboxylic acid polymers; unneutralized modified crosslinked carboxylic acid polymers; crosslinked ethylene/maleic anhydride copolymers; unneutralized crosslinked ethylene/maleic anhydride copolymers (e.g., EMA 81 commercially available from Monsanto); unneutralized crosslinked alkyl ether/acrylate copolymers (e.g., SALCARE™ SC90 commercially available from Allied Colloids); unneutralized crosslinked copolymers of sodium polyacrylate, mineral oil, and PEG-1 trideceth-6 (e.g., SALCARE™ SC91 commercially available from Allied Colloids); unneutralized crosslinked copolymers of methyl vinyl ether and maleic anhydride (e.g., STABILEZE™ QM-PVM/MA copolymer commercially available from International Specialty Products); hydrophobically modified nonionic cellulose polymers; hydrophobically modified ethoxylate urethane polymers (e.g., UCARE™ Polyphobe Series of alkali swellable polymers commercially available from Union Carbide); and combinations thereof. In this context, the term “unneutralized” means that the optional polymer and copolymer gelling agent materials contain unneutralized acid monomers. Preferred gelling agents include water-soluble unneutralized crosslinked ethylene/maleic anhydride copolymers, water-soluble unneutralized crosslinked carboxylic acid polymers, water-soluble hydrophobically modified nonionic cellulose polymers and surfactant/fatty alcohol gel networks such as those suitable for use in hair conditioning products.

The polysaccharide derivatives described herein may be incorporated into hair care compositions and products, such as but not limited to, hair conditioning agents. Hair conditioning agents are well known in the art, see for example Green et al. (WO 0107009), and are available commercially from various sources. Suitable examples of hair conditioning agents include, but are not limited to, cationic polymers, such as cationized guar gum, diallyl quaternary ammonium salt/acrylamide copolymers, quaternized polyvinylpyrrolidone and derivatives thereof, and various polyquaternium-compounds; cationic surfactants, such as stearalkonium chloride, centrimonium chloride, and sapamin hydrochloride; fatty alcohols, such as behenyl alcohol; fatty amines, such as stearyl amine; waxes; esters; nonionic polymers, such as polyvinylpyrrolidone, polyvinyl alcohol, and polyethylene glycol; silicones; siloxanes, such as decamethylcyclopentasiloxane; polymer emulsions, such as amodimethicone; and nanoparticles, such as silica nanoparticles and polymer nanoparticles.

The hair care products may also include additional components typically found in cosmetically acceptable media. Non-limiting examples of such components are disclosed in International Cosmetic Ingredient Dictionary, Ninth Edition, 2002, and CTFA Cosmetic Ingredient Handbook, Tenth Edition, 2004. A non-limiting list of components often included in a cosmetically acceptable medium for hair care are also described by Philippe et al. in U.S. Pat. No. 6,280,747, and by Omura et al. in U.S. Pat. No. 6,139,851 and Cannell et al. in U.S. Pat. No. 6,013,250, all of which are incorporated herein by reference. For example, hair care compositions can be aqueous, alcoholic or aqueous-alcoholic solutions, the alcohol preferably being ethanol or isopropanol, in a proportion of from about 1 to about 75% by weight relative to the total weight, for the aqueous-alcoholic solutions. Additionally, the hair care compositions may contain one or more conventional cosmetic or dermatological additives or adjuvants including but not limited to, antioxidants, preserving agents, fillers, surfactants, UVA and/or UVB sunscreens, fragrances, thickeners, gelling agents, wetting agents and anionic, nonionic or amphoteric polymers, and dyes or pigments.

The hair care compositions and methods may also include at least one coloring agents such as any dye, lake, pigment, and the like that may be used to change the color of hair, skin, or nails. Hair coloring agents are well known in the art (see for example Green et al. supra, CFTA International Color Handbook, 2^{nd} ed., Micelle Press, England (1992) and Cosmetic Handbook, US Food and Drug Administration, FDA/IAS Booklet (1992)), and are available commercially from various sources (for example Bayer, Pittsburgh, PA; Ciba-Geigy, Tarrytown, NY; ICI, Bridgewater, NJ; Sandoz, Vienna, Austria; BASF, Mount Olive, NJ; and Hoechst, Frankfurt, Germany). Suitable hair coloring agents include, but are not limited to dyes, such as 4-hydroxypropylamino-3-nitrophenol, 4-amino-3-nitrophenol, 2-amino-6-chloro-4-nitrophenol, 2-nitro-paraphenylenediamine, N,N-hydroxyethyl-2-nitro-phenylenediamine, 4-nitro-indole, Henna, HC Blue 1, HC Blue 2, HC Yellow 4, HC Red 3, HC Red 5, Disperse Violet 4, Disperse Black 9, HC Blue 7, HC Blue 12, HC Yellow 2, HC Yellow 6, HC Yellow 8, HC Yellow 12, HC Brown 2, D&C Yellow 1, D&C Yellow 3, D&C Blue 1, Disperse Blue 3, Disperse violet 1, eosin derivatives such as D&C Red No. 21 and halogenated fluorescein derivatives such as D&C Red No. 27, D&C Red Orange No. 5 in combination with D&C Red No. 21 and D&C Orange No. 10; and pigments, such as D&C Red No. 36 and D&C Orange No. 17, the calcium lakes of D&C Red Nos. 7, 11, 31 and 34, the barium lake of D&C Red No. 12, the strontium lake of D&C Red No. 13, the aluminum lakes of FD&C Yellow No. 5, of FD&C Yellow No. 6, of D&C Red No. 27, of D&C Red No. 21, and of FD&C Blue No. 1, iron oxides, manganese violet, chromium oxide, titanium dioxide, titanium dioxide nanoparticles, zinc oxide, barium oxide, ultramarine blue, bismuth citrate, and carbon black particles. In one embodiment, the hair coloring agents are D&C Yellow 1 and 3, HC Yellow 6 and 8, D&C Blue 1, HC Blue 1, HC Brown 2, HC Red 5, 2-nitro-paraphenylenediamine, N,N-hydroxyethyl-2-nitro-phenylenediamine, 4-nitro-indole, and carbon black. Metallic and semiconductor nanoparticles may also be used as hair coloring agents due to their strong emission of light (U.S. Patent Application Publication No. 2004-0010864 to Vic et al.).

Hair care compositions may include, but are not limited to, shampoos, conditioners, lotions, aerosols, gels, mousses, and hair dyes.

Personal care products may be in the form of lotions, creams, pastes, balms, ointments, pomades, gels, liquids, or combinations thereof. A personal care product can also be in the form of makeup, lipstick, mascara, rouge, foundation, blush, eyeliner, lip liner, lip gloss, other cosmetics, sunscreen, sun block, nail polish, mousse, hair spray, styling gel, nail conditioner, bath gel, shower gel, body wash, face wash, shampoo, hair conditioner (leave-in or rinse-out), cream rinse, hair dye, hair coloring product, hair shine product, hair serum, hair anti-frizz product, hair split-end repair product, lip balm, skin conditioner, cold cream, moisturizer, body spray, soap, body scrub, exfoliant, astringent, scruffing lotion, depilatory, permanent waving solution, antidandruff formulation, antiperspirant composition, deodorant, shaving product, pre-shaving product, after-shaving product, cleanser, skin gel, rinse, dentifrice composition, toothpaste, or mouthwash, for example.

Personal care products can include a polysaccharide derivative as disclosed herein, and can further comprise personal care active ingredient materials including sun screen agents, moisturizers, humectants, benefiting agents for hair, skin, nails and mouth, depositing agents such as surfactants, occlusive agents, moisture barriers, lubricants, emollients, anti-aging agents, antistatic agents, abrasive, antimicrobials, conditioners, exfoliants, fragrances, viscosifying agents, salts, lipids, phospholipids, vitamins, foam stabilizers, pH modifiers, preservatives, suspending agents, silicone oils, silicone derivatives, essential oils, oils, fats, fatty acids, fatty acid esters, fatty alcohols, waxes, polyols, hydrocarbons, and mixtures thereof. An active ingredient is generally recognized as an ingredient that causes an intended pharmacological effect.

In certain embodiments, a skin care product can include at least one active ingredient for the treatment or prevention of skin ailments, providing a cosmetic effect, or for providing a moisturizing benefit to skin, such as zinc oxide, petrolatum, white petrolatum, mineral oil, cod liver oil, lanolin, dimethicone, hard fat, vitamin A, allantoin, calamine, kaolin, glycerin, or colloidal oatmeal, and combinations of these. A skin care product may include one or more natural moisturizing factors such as ceramides, hyaluronic acid, glycerin, squalane, amino acids, cholesterol, fatty acids, triglycerides, phospholipids, glycosphingolipids, urea, linoleic acid, glycosaminoglycans, mucopolysaccharide, sodium lactate, or sodium pyrrolidone carboxylate, for example. Other ingredients that may be included in a skin care product include, without limitation, glycerides, apricot kernel oil, canola oil, squalane, squalene, coconut oil, corn oil, jojoba oil, jojoba wax, lecithin, olive oil, safflower oil, sesame oil, shea butter, soybean oil, sweet almond oil, sunflower oil, tea tree oil, shea butter, palm oil, cholesterol, cholesterol esters, wax esters, fatty acids, and orange oil.

Personal care compositions disclosed herein can be in the form of an oral care composition. Examples of oral care compositions include dentifrices, toothpaste, mouth wash, mouth rinse, chewing gum, and edible strips that provide some form of oral care (e.g., treatment or prevention of cavities [dental caries], gingivitis, plaque, tartar, and/or periodontal disease). An oral care composition can also be for treating an “oral surface”, which encompasses any soft or hard surface within the oral cavity including surfaces of the tongue, hard and soft palate, buccal mucosa, gums and dental surfaces. A “dental surface” herein is a surface of a natural tooth or a hard surface of artificial dentition including a crown, cap, filling, bridge, denture, or dental implant, for example.

One or more polysaccharide derivatives comprised in an oral care composition typically are provided therein as a thickening agent and/or dispersion agent, which may be useful to impart a desired consistency and/or mouth feel to the composition. An oral care composition herein can comprise about 0.01-15.0 wt % (e.g., ˜0.1-10 wt % or ˜0.1-5.0 wt %, ˜0.1-2.0 wt %) of one or more polysaccharide derivatives disclosed herein. One or more other thickening agents or dispersion agents can also be provided in an oral care composition herein, such as a carboxyvinyl polymer, carrageenan (e.g., L-carrageenan), natural gum (e.g., karaya, xanthan, gum arabic, tragacanth), colloidal magnesium aluminum silicate, or colloidal silica, for example.

An oral care composition herein may be a toothpaste or other dentifrice, for example. Such compositions, as well as any other oral care composition herein, can additionally comprise, without limitation, one or more of an anticaries agent, antimicrobial or antibacterial agent, anticalculus or tartar control agent, surfactant, abrasive, pH-modifying agent, foam modulator, humectant, flavorant, sweetener, pigment/colorant, whitening agent, and/or other suitable components.

An anticaries agent herein can be an orally acceptable source of fluoride ions. Suitable sources of fluoride ions include fluoride, monofluorophosphate and fluorosilicate salts as well as amine fluorides, including olaflur (N′-octadecyltrimethylendiamine-N,N, N′-tris(2-ethanol)-dihydrofluoride), for example. An anticaries agent can be present in an amount providing a total of about 100-20000 ppm, about 200-5000 ppm, or about 500-2500 ppm, fluoride ions to the composition, for example. In oral care compositions in which sodium fluoride is the sole source of fluoride ions, an amount of about 0.01-5.0 wt %, about 0.05-1.0 wt %, or about 0.1-0.5 wt %, sodium fluoride can be present in the composition, for example.

An antimicrobial or antibacterial agent suitable for use in an oral care composition herein includes, for example, phenolic compounds (e.g., 4-allylcatechol; p-hydroxybenzoic acid esters such as benzylparaben, butylparaben, ethylparaben, methylparaben and propylparaben; 2-benzylphenol; butylated hydroxyanisole; butylated hydroxytoluene; capsaicin; carvacrol; creosol; eugenol; guaiacol; halogenated bisphenolics such as hexachlorophene and bromochlorophene; 4-hexylresorcinol; 8-hydroxyquinoline and salts thereof; salicylic acid esters such as menthyl salicylate, methyl salicylate and phenyl salicylate; phenol; pyrocatechol; salicylanilide; thymol; halogenated diphenylether compounds such as triclosan and triclosan monophosphate), copper (II) compounds (e.g., copper (II) chloride, fluoride, sulfate and hydroxide), zinc ion sources (e.g., zinc acetate, citrate, gluconate, glycinate, oxide, and sulfate), phthalic acid and salts thereof (e.g., magnesium monopotassium phthalate), hexetidine, octenidine, sanguinarine, benzalkonium chloride, domiphen bromide, alkylpyridinium chlorides (e.g. cetylpyridinium chloride, tetradecylpyridinium chloride, N-tetradecyl-4-ethylpyridinium chloride), iodine, sulfonamides, bisbiguanides (e.g., alexidine, chlorhexidine, chlorhexidine digluconate), piperidino derivatives (e.g., delmopinol, octapinol), magnolia extract, grapeseed extract, rosemary extract, menthol, geraniol, citral, eucalyptol, antibiotics (e.g., augmentin, amoxicillin, tetracycline, doxycycline, minocycline, metronidazole, neomycin, kanamycin, clindamycin), and/or any antibacterial agents disclosed in U.S. Pat. No. 5,776,435, which is incorporated herein by reference. One or more antimicrobial agents can optionally be present at about 0.01-10 wt % (e.g., 0.1-3 wt %), for example, in the disclosed oral care composition.

An anticalculus or tartar control agent suitable for use in an oral care composition herein includes, for example, phosphates and polyphosphates (e.g., pyrophosphates), polyaminopropanesulfonic acid (AMPS), zinc citrate trihydrate, polypeptides (e.g., polyaspartic and polyglutamic acids), polyolefin sulfonates, polyolefin phosphates, diphosphonates (e.g.,azacycloalkane-2,2-diphosphonates such as azacycloheptane-2,2-diphosphonic acid), N-methyl azacyclopentane-2,3-diphosphonic acid, ethane-1-hydroxy-1,1-diphosphonic acid (EHDP), ethane-1-amino-1,1-diphosphonate, and/or phosphonoalkane carboxylic acids and salts thereof (e.g., their alkali metal and ammonium salts). Useful inorganic phosphate and polyphosphate salts include, for example, monobasic, dibasic and tribasic sodium phosphates, sodium tripolyphosphate, tetrapolyphosphate, mono-, di-, tri- and tetra-sodium pyrophosphates, disodium dihydrogen pyrophosphate, sodium trimetaphosphate, sodium hexametaphosphate, or any of these in which sodium is replaced by potassium or ammonium. Other useful anticalculus agents in certain embodiments include anionic polycarboxylate polymers (e.g., polymers or copolymers of acrylic acid, methacrylic, and maleic anhydride such as polyvinyl methyl ether/maleic anhydride copolymers). Still other useful anticalculus agents include sequestering agents such as hydroxycarboxylic acids (e.g., citric, fumaric, malic, glutaric and oxalic acids and salts thereof) and aminopolycarboxylic acids (e.g., EDTA). One or more anticalculus or tartar control agents can optionally be present at about 0.01-50 wt % (e.g., about 0.05-25 wt % or about 0.1-15 wt %), for example, in the disclosed oral care composition.

A surfactant suitable for use in an oral care composition herein may be anionic, non-ionic, or amphoteric, for example. Suitable anionic surfactants include, without limitation, water-soluble salts of C₈₋₂₀ alkyl sulfates, sulfonated monoglycerides of C₈₋₂₀ fatty acids, sarcosinates, and taurates. Examples of anionic surfactants include sodium lauryl sulfate, sodium coconut monoglyceride sulfonate, sodium lauryl sarcosinate, sodium lauryl isoethionate, sodium laureth carboxylate and sodium dodecyl benzenesulfonate. Suitable non-ionic surfactants include, without limitation, poloxamers, polyoxyethylene sorbitan esters, fatty alcohol ethoxylates, alkylphenol ethoxylates, tertiary amine oxides, tertiary phosphine oxides, and dialkyl sulfoxides. Suitable amphoteric surfactants include, without limitation, derivatives of C₈₋₂₀ aliphatic secondary and tertiary amines having an anionic group such as a carboxylate, sulfate, sulfonate, phosphate or phosphonate. An example of a suitable amphoteric surfactant is cocoamidopropyl betaine. One or more surfactants are optionally present in a total amount of about 0.01-10 wt % (e.g., about 0.05-5.0 wt % or about 0.1-2.0 wt %), for example, in the disclosed oral care composition.

An abrasive suitable for use in an oral care composition herein may include, for example, silica (e.g., silica gel, hydrated silica, precipitated silica), alumina, insoluble phosphates, calcium carbonate, and resinous abrasives (e.g., a urea-formaldehyde condensation product). Examples of insoluble phosphates useful as abrasives herein are orthophosphates, polymetaphosphates and pyrophosphates, and include dicalcium orthophosphate dihydrate, calcium pyrophosphate, beta-calcium pyrophosphate, tricalcium phosphate, calcium polymetaphosphate and insoluble sodium polymetaphosphate. One or more abrasives are optionally present in a total amount of about 5-70 wt % (e.g., about 10-56 wt % or about 15-30 wt %), for example, in the disclosed oral care composition. The average particle size of an abrasive in certain embodiments is about 0.1-30 microns (e.g., about 1-20 microns or about 5-15 microns).

An oral care composition in certain embodiments may comprise at least one pH-modifying agent. Such agents may be selected to acidify, make more basic, or buffer the pH of a composition to a pH range of about 2-10 (e.g., pH ranging from about 2-8, 3-9, 4-8, 5-7, 6-10, or 7-9). Examples of pH-modifying agents useful herein include, without limitation, carboxylic, phosphoric and sulfonic acids; acid salts (e.g., monosodium citrate, disodium citrate, monosodium malate); alkali metal hydroxides (e.g. sodium hydroxide, carbonates such as sodium carbonate, bicarbonates, sesquicarbonates); borates; silicates; phosphates (e.g., monosodium phosphate, trisodium phosphate, pyrophosphate salts); and imidazole.

A foam modulator suitable for use in an oral care composition herein may be a polyethylene glycol (PEG), for example. High molecular weight PEGs are suitable, including those having an average molecular weight of about 200000-7000000 (e.g., about 500000-5000000 or about 1000000-2500000), for example. One or more PEGs are optionally present in a total amount of about 0.1-10 wt % (e.g. about 0.2-5.0 wt % or about 0.25-2.0 wt %), for example, in the disclosed oral care composition.

An oral care composition in certain embodiments may comprise at least one humectant. A humectant in certain embodiments may be a polyhydric alcohol such as glycerin, sorbitol, xylitol, or a low molecular weight PEG. Most suitable humectants also may function as a sweetener herein. One or more humectants are optionally present in a total amount of about 1.0-70 wt % (e.g., about 1.0-50 wt %, about 2-25 wt %, or about 5-15 wt %), for example, in the disclosed oral care composition.

A natural or artificial sweetener may optionally be comprised in an oral care composition herein. Examples of suitable sweeteners include dextrose, sucrose, maltose, dextrin, invert sugar, mannose, xylose, ribose, fructose, levulose, galactose, corn syrup (e.g., high fructose corn syrup or corn syrup solids), partially hydrolyzed starch, hydrogenated starch hydrolysate, sorbitol, mannitol, xylitol, maltitol, isomalt, aspartame, neotame, saccharin and salts thereof, dipeptide-based intense sweeteners, and cyclamates. One or more sweeteners are optionally present in a total amount of about 0.005-5.0 wt %, for example, in the disclosed oral care composition.

A natural or artificial flavorant may optionally be comprised in an oral care composition herein. Examples of suitable flavorants include vanillin; sage; marjoram; parsley oil; spearmint oil; cinnamon oil; oil of wintergreen (methylsalicylate); peppermint oil; clove oil; bay oil; anise oil; eucalyptus oil; citrus oils; fruit oils; essences such as those derived from lemon, orange, lime, grapefruit, apricot, banana, grape, apple, strawberry, cherry, or pineapple; bean- and nut-derived flavors such as coffee, cocoa, cola, peanut, or almond; and adsorbed and encapsulated flavorants. Also encompassed within flavorants herein are ingredients that provide fragrance and/or other sensory effect in the mouth, including cooling or warming effects. Such ingredients include, without limitation, menthol, menthyl acetate, menthyl lactate, camphor, eucalyptus oil, eucalyptol, anethole, eugenol, cassia, oxanone, Irisone®, propenyl guaiethol, thymol, linalool, benzaldehyde, cinnamaldehyde, N-ethyl-p-menthan-3-carboxamine, N,2,3-trimethyl-2-isopropylbutanamide, 3-(1-menthoxy)-propane-1,2-diol, cinnamaldehyde glycerol acetal (CGA), and menthone glycerol acetal (MGA). One or more flavorants are optionally present in a total amount of about 0.01-5.0 wt % (e.g., about 0.1-2.5 wt %), for example, in the disclosed oral care composition.

An oral care composition in certain embodiments may comprise at least one bicarbonate salt. Any orally acceptable bicarbonate can be used, including alkali metal bicarbonates such as sodium or potassium bicarbonate, and ammonium bicarbonate, for example. One or more bicarbonate salts are optionally present in a total amount of about 0.1-50 wt % (e.g., about 1-20 wt %), for example, in the disclosed oral care composition.

An oral care composition in certain embodiments may comprise at least one whitening agent and/or colorant. A suitable whitening agent is a peroxide compound such as any of those disclosed in U.S. Pat. No. 8,540,971, which is incorporated herein by reference. Suitable colorants herein include pigments, dyes, lakes and agents imparting a particular luster or reflectivity such as pearling agents, for example. Specific examples of colorants useful herein include talc; mica; magnesium carbonate; calcium carbonate; magnesium silicate; magnesium aluminum silicate; silica; titanium dioxide; zinc oxide; red, yellow, brown and black iron oxides; ferric ammonium ferrocyanide; manganese violet; ultramarine; titaniated mica; and bismuth oxychloride. One or more colorants are optionally present in a total amount of about 0.001-20 wt % (e.g., about 0.01-10 wt % or about 0.1-5.0 wt %), for example, in the disclosed oral care composition.

Additional components that can optionally be included in an oral composition herein include one or more enzymes (above), vitamins, and anti-adhesion agents, for example. Examples of vitamins useful herein include vitamin C, vitamin E, vitamin B5, and folic acid. Examples of suitable anti-adhesion agents include solbrol, ficin, and quorum-sensing inhibitors.

The composition can be in any useful form, for example, as powders, granules, pastes, bars, unit dose, or liquid.

The unit dose form may be water-soluble, for example, a water-soluble unit dose article comprising a water-soluble film and a liquid or solid laundry detergent composition, also referred to as a pouch. A water-soluble unit dose pouch comprises a water-soluble film which fully encloses the liquid or solid detergent composition in at least one compartment. The water-soluble unit dose article may comprise a single compartment or multiple compartments. The water-soluble unit dose article may comprise at least two compartments or at least three compartments. The compartments may be arranged in a superposed orientation or in a side-by-side orientation.

A unit dose article is typically a closed structure, made of the water-soluble film enclosing an internal volume which comprises the liquid or solid laundry detergent composition. The pouch can be of any form and shape which is suitable to hold and protect the composition, e.g. without allowing the release of the composition from the pouch prior to contact of the pouch to water.

A liquid detergent composition may be aqueous, typically containing up to about 70% by weight of water and 0% to about 30% by weight of organic solvent. It may also be in the form of a compact gel type containing less than or equal to 30% by weight water.

A polysaccharide derivative as disclosed herein can be used as an ingredient in the desired product or may be blended with one or more additional suitable ingredients and used as, for example, an industrial product, a household product, fabric care applications, laundry care applications, and/or personal care applications. Any of the disclosed compositions, for example, an industrial product, a household product, a fabric care, a laundry care or a personal care composition can comprise in the range of 0.01 to 99 percent by weight of the polysaccharide derivative, based on the total dry weight of the composition (dry solids basis). The term “total dry weight” means the weight of the composition excluding any solvent, for example, any water that might be present. In other embodiments, the composition comprises 0.1 to 10% or 0.1 to 9% or 0.5 to 8% or 1 to 7% or 1 to 6% or 1 to 5% or 1 to 4% or 1 to 3% or 5 to 10% or 10 to 15% or 15 to 20% or 20 to 25% or 25 to 30% or 30 to 35% or 35 to 40% or 40 to 45% or 45 to 50% or 50 to 55% or 55 to 60% or 60 to 65% or 65 to 70% or 70 to 75% or 75 to 80% or 80 to 85% or 85 to 90% or 90 to 95% or 95 to 99% by weight of the polysaccharide derivative, wherein the percentages by weight are based on the total dry weight of the composition.

The composition can further comprise at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer inhibiting agent, a chelating agent, a hueing dye, a calcium cation, a magnesium cation, a visual signaling ingredient, an anti-foam, a structurant, a thickener, an anti-caking agent, a starch, sand, a gelling agents, or a combination thereof. In one embodiment, the enzyme is a cellulase. In another embodiment, the enzyme is a protease. In yet another embodiment, the enzyme is an amylase. In a further embodiment, the enzyme is a lipase.

The composition can be a detergent composition useful for, for example, fabric care, laundry care and/or personal care and may further contain one or more active enzymes. Non-limiting examples of suitable enzymes include proteases, cellulases, hemicellulases, peroxidases, lipolytic enzymes (e.g., metallolipolytic enzymes), xylanases, phospholipases, perhydrolases, cutinases, pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, amylases or a combination thereof. If an enzyme(s) is included, it may be present in the composition at about 0.0001 to 0.1% by weight of the active enzyme, based on the total weight of the composition. In other embodiments, the enzyme can be present at about 0.01 to 0.03% by weight of the active enzyme (e.g., calculated as pure enzyme protein) based on the total weight of the composition. In some embodiments, a combination of two or more enzymes can be used in the composition. In some embodiments, the two or more enzymes are cellulase and one or more of proteases, hemicellulases, peroxidases, lipolytic enzymes, xylanases, lipases, phospholipases, esterases, perhydrolases, cutinases, pectinases, pectate lyases, mannanases, keratinases, reductases, oxidases, phenoloxidases, lipoxygenases, ligninases, pullulanases, tannases, pentosanases, malanases, beta- glucanases, arabinosidases, hyaluronidases, chondroitinases, laccases, metalloproteinases, amadoriases, glucoamylases, arabinofuranosidases, phytases, isomerases, transferases, amylases or a combination thereof.

In some embodiments, the composition can comprise one or more enzymes, each enzyme present from about 0.00001% to about 10% by weight, based on the total weight of the composition. In some embodiments, the composition can also comprise each enzyme at a level of about 0.0001% to about 10%, about 0.001% to about 5%, about 0.001% to about 2% or about 0.005% to about 0.5% by weight, based on the total weight of the composition.

A cellulase can have endocellulase activity (EC 3.2.1.4), exocellulase activity (EC 3.2.1.91), or cellobiase activity (EC 3.2.1.21). A cellulase is an “active cellulase” having activity under suitable conditions for maintaining cellulase activity; it is within the skill of the art to determine such suitable conditions. Besides being able to degrade cellulose, a cellulase in certain embodiments can also degrade cellulose ether derivatives such as carboxymethyl cellulose.

The cellulase may be derived from any microbial source, such as a bacteria or fungus. Chemically-modified cellulases or protein-engineered mutant cellulases are included. Suitable cellulases include, for example, cellulases from the genera Bacillus, Pseudomonas, Streptomyces, Trichoderma, Humicola, Fusarium, Thielavia and Acremonium. As other examples, the cellulase may be derived from Humicola insolens, Myceliophthora thermophile, Fusarium oxysporum, Trichoderma reesei or a combination thereof. The cellulase, such as any of the foregoing, can be in a mature form lacking an N-terminal signal peptide. Commercially available cellulases useful herein include CELLUSOFT®, CELLUCLEAN®, CELLUZYME® and CAREZYME® (Novozymes A/S); CLAZINASE® and PURADAX® HA and REVITALENZ™ (DuPont Industrial Biosciences), BIOTOUCH® (AB Enzymes); and KAC-500 (B)® (Kao Corporation).

Alternatively, a cellulase herein may be produced by any means known in the art, for example, a cellulase may be produced recombinantly in a heterologous expression system, such as a microbial or fungal heterologous expression system. Examples of heterologous expression systems include bacterial (e.g., E. coli, Bacillus sp.) and eukaryotic systems. Eukaryotic systems can employ yeast (e.g., Pichia sp., Saccharomyces sp.) or fungal (e.g., Trichoderma sp. such as T. reesei, Aspergillus species such as A. niger) expression systems, for example.

The cellulase in certain embodiments can be thermostable. Cellulase thermostability refers to the ability of the enzyme to retain activity after exposure to an elevated temperature (e.g. about 60-70° C.) for a period of time (e.g., about 30-60 minutes). The thermostability of a cellulase can be measured by its half-life (t1/2) given in minutes, hours, or days, during which time period half the cellulase activity is lost under defined conditions.

The cellulase in certain embodiments can be stable to a wide range of pH values (e.g. neutral or alkaline pH such as pH of ˜7.0 to ˜11.0). Such enzymes can remain stable for a predetermined period of time (e.g., at least about 15 min., 30 min., or 1 hour) under such pH conditions.

At least one, two, or more cellulases may be included in the composition. The total amount of cellulase in a composition herein typically is an amount that is suitable for the purpose of using cellulase in the composition (an “effective amount”). For example, an effective amount of cellulase in a composition intended for improving the feel and/or appearance of a cellulose-containing fabric is an amount that produces measurable improvements in the feel of the fabric (e.g., improving fabric smoothness and/or appearance, removing pills and fibrils which tend to reduce fabric appearance sharpness). As another example, an effective amount of cellulase in a fabric stonewashing composition herein is that amount which will provide the desired effect (e.g., to produce a worn and faded look in seams and on fabric panels). The amount of cellulase in a composition herein can also depend on the process parameters in which the composition is employed (e.g., equipment, temperature, time, and the like) and cellulase activity, for example. The effective concentration of cellulase in an aqueous composition in which a fabric is treated can be readily determined by a skilled artisan. In fabric care processes, cellulase can be present in an aqueous composition (e.g., wash liquor) in which a fabric is treated in a concentration that is minimally about 0.01-0.1 ppm total cellulase protein, or about 0.1-10 ppb total cellulase protein (e.g., less than 1 ppm), to maximally about 100, 200, 500, 1000, 2000, 3000, 4000, or 5000 ppm total cellulase protein, for example.

Suitable enzymes are known in the art and can include, for example, MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (Genencor); ALCALASE®, SAVINASE®, PRIMASE®, DURAZYM™ POLARZYME®, OVOZYME®, KANNASE®, LIQUANASE®, NEUTRASE®, RELASE® and ESPERASE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan) proteases; MANNASTAR®, PURABRITE™, and MANNAWAY® mannanases; M1 LIPASE™, LUMA FAST™, and LIPOMAX™ (Genencor); LIPEX®, LIPOLASE® and LIPOLASE® ULTRA (Novozymes); and LIPASE PT™ “Amano” (Amano Pharmaceutical Co. Ltd., Japan) lipases; STAINZYME®, STAINZYME PLUS®, NATALASE®, DURAMYL®, TERMAMYL®, TERMAMYL ULTRA®, FUNGAMYL® and BAN™ (Novo Nordisk A/S and Novozymes A/S); RAPIDASE®, POWERASE®, PURASTAR® and PREFERENZ™ (DuPont Industrial Biosciences) amylases; GUARDZYME™ (Novo Nordisk A/S and Novozymes A/S) peroxidases or a combination thereof.

In some embodiments, the enzymes in the composition can be stabilized using conventional stabilizing agents, e.g., a polyol such as propylene glycol or glycerol; a sugar or sugar alcohol; lactic acid; boric acid or a boric acid derivative (e.g., an aromatic borate ester).

A detergent composition herein typically comprises one or more surfactants, wherein the surfactant is selected from nonionic surfactants, anionic surfactants, cationic surfactants, ampholytic surfactants, zwitterionic surfactants, semi-polar nonionic surfactants and mixtures thereof. The surfactant may be petroleum-derived (also referred to as synthetic) or non-petroleum-derived (also referred to as natural). In some embodiments, the surfactant is present at a level of from about 0.1% to about 60%, while in alternative embodiments the level is from about 1% to about 50%, while in still further embodiments the level is from about 5% to about 40%, by weight of the cleaning composition. A detergent will usually contain 0% to about 50% by weight of an anionic surfactant such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl-or alkenylsuccinic acid, or soap.

The detergent composition may comprise an alcohol ethoxysulfate of the formula R¹—(OCH₂CH₂)ₓ—O—SO₃M, wherein R¹ is a non-petroleum derived, linear or branched fatty alcohol consisting of even numbered carbon chain lengths of from about C₈ to about C₂₀, and wherein x is from about 0.5 to about 8, and where M is an alkali metal or ammonium cation. The fatty alcohol portion of the alcohol ethoxysulfate (R¹) is derived from a renewable source (e.g., animal or plant derived) rather than geologically derived (e.g., petroleum-derived). Fatty alcohols derived from a renewable source may be referred to as natural fatty alcohols. Natural fatty alcohols have an even number of carbon atoms with a single alcohol (—OH) attached to the terminal carbon. The fatty alcohol portion of the surfactant (R¹) may comprise distributions of even number carbon chains, e.g., C₁₂, C₁₄, C₁₆, C₁₈, and so forth.

In addition, a detergent composition may optionally contain 0 wt % to about 40 wt % of a nonionic surfactant such as alcohol ethoxylate (AEO or AE), carboxylated alcohol ethoxylates, nonylphenol ethoxylate, alkylpolyglycoside, alkyldimethylamineoxide, ethoxylated fatty acid monoethanolamide, fatty acid monoethanolamide, or polyhydroxy alkyl fatty acid amide. The detergent composition may comprise an alcohol ethoxylate of formula R²—(OCH₂CH₂)_{y}—OH, wherein R² is a non-petroleum derived, linear or branched fatty alcohol consisting of even numbered carbon chain lengths of from about C₁₀ to about C₁₈, and wherein y is from about 0.5 to about 15. The fatty alcohol portion of the alcohol ethoxylate (R²) is derived from a renewable source (e.g., animal or plant derived) rather than geologically derived (e.g., petroleum-derived). The fatty alcohol portion of the surfactant (R²) may comprise distributions of even number carbon chains, e.g., C₁₂, C₁₄, C₁₆, C₁₈, and so forth.

The composition can further comprise one or more detergent builders or builder systems. In some embodiments incorporating at least one builder, the compositions comprise at least about 1%, from about 3% to about 60% or from about 5% to about 40% by weight of the builder, based on the total weight of the composition. Builders include, for example, the alkali metal, ammonium and/or alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof. Examples of a detergent builder or complexing agent include zeolite, diphosphate, triphosphate, phosphonate, citrate, nitrilotriacetic acid (NTA), ethylenediaminetetraacetic acid (EDTA), diethylenetriaminepentaacetic acid (DTMPA), alkyl-or alkenylsuccinic acid, soluble silicates or layered silicates (e.g., SKS-6 from Hoechst). A detergent may also be unbuilt, i.e., essentially free of detergent builder.

The composition can further comprise at least one chelating agent. Suitable chelating agents include, for example, copper, iron and/or manganese chelating agents and mixtures thereof. In some embodiments in which at least one chelating agent is used, the compositions comprise from about 0.1% to about 15% or even from about 3.0% to about 10% by weight of the chelating agent, based on the total weight of the composition.

The composition can further comprise at least one deposition aid. Suitable deposition aids include, for example, polyethylene glycol, polypropylene glycol, polycarboxylate, soil release polymers such as polytelephthalic acid, clays such as kaolinite, montmorillonite, atapulgite, illite, bentonite, halloysite, or a combination thereof.

The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetri-acetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof. In embodiments in which at least one dye transfer inhibiting agent is used, the compositions can comprise from about 0.0001% to about 10%, from about 0.01% to about 5%, or even from about 0.1% to about 3% by weight of the dye transfer inhibiting agent, based on the total weight of the composition.

The composition can further comprise silicates. Suitable silicates can include, for example, sodium silicates, sodium disilicate, sodium metasilicate, crystalline phyllosilicates or a combination thereof. In some embodiments, silicates can be present at a level of from about 1% to about 20% by weight, based on the total weight of the composition. In other embodiments, silicates can be present at a level of from about 5% to about 15% by weight, based on the total weight of the composition.

The composition can further comprise dispersants. Suitable water-soluble organic materials can include, for example, homo- or co-polymeric acids or their salts, in which the polycarboxylic acid comprises at least two carboxyl radicals separated from each other by not more than two carbon atoms.

The composition can further comprise one or more other types of polymers in addition to the present polysaccharide derivative. Examples of other types of polymers useful herein include carboxymethyl cellulose (CMC), poly(vinylpyrrolidone) (PVP), polyethylene glycol (PEG), poly(vinyl alcohol) (PVA), polycarboxylates such as polyacrylates, maleic/acrylic acid copolymers and lauryl methacrylate/acrylic acid copolymers.

The composition can further comprise a bleaching system. For example, the bleaching system can comprise an H₂O₂ source such as perborate, percarbonate, perhydrate salts, mono or tetra hydrate sodium salt of perborate, persulfate, perphosphate, persilicate, percarboxylic acids and salts, percarbonic acids and salts, perimidic acids and salts, peroxymonosulfuric acids and salts, sulfonated zinc phthalocyanines, sulfonated aluminum phthalocyanines, xanthene dyes which may be combined with a peracid-forming bleach activator such as, for example, dodecanoyl oxybenzene sulfonate, decanoyl oxybenzene sulfonate, decanoyl oxybenzoic acid or salts thereof, tetraacetylethylenediamine (TAED) or nonanoyloxybenzenesulfonate (NOBS). Alternatively, a bleaching system may comprise peroxyacids (e.g., amide, imide, or sulfone type peroxyacids). In other embodiments, the bleaching system can be an enzymatic bleaching system comprising perhydrolase. Combinations of any of the above may also be used.

The composition can further comprise conventional detergent ingredients such as fabric conditioners, clays, foam boosters, suds suppressors, anti-corrosion agents, soil-suspending agents, anti-soil redeposition agents, dyes, bactericides, tarnish inhibiters, optical brighteners, or perfumes. The pH of a detergent composition herein (measured in aqueous solution at use concentration) can be neutral or alkaline (e.g., pH of about 7.0 to about 11.0).

The composition can be a detergent composition and optionally, a heavy duty (all purpose) laundry detergent composition. In some embodiments, the detergent composition can comprise a detersive surfactant (10%- 40% wt/wt), including an anionic detersive surfactant (selected from a group of linear or branched or random chain, substituted or unsubstituted alkyl sulphates, alkyl sulphonates, alkyl alkoxylated sulphate, alkyl phosphates, alkyl phosphonates, alkyl carboxylates, and/or mixtures thereof), and optionally non-ionic surfactant (selected from a group of linear or branched or random chain, substituted or unsubstituted alkyl alkoxylated alcohol, e.g., C₈-C₁₈ alkyl ethoxylated alcohols and/or C₆-C₁₂ alkyl phenol alkoxylates), where the weight ratio of anionic detersive surfactant (with a hydrophilic index (Hlc) of from 6.0 to 9) to non-ionic detersive surfactant is greater than 1:1. Suitable detersive surfactants also include cationic detersive surfactants (selected from a group of alkyl pyridinium compounds, alkyl quaternary ammonium compounds, alkyl quaternary phosphonium compounds, alkyl ternary sulphonium compounds, and/or mixtures thereof); zwitterionic and/or amphoteric detersive surfactants (selected from a group of alkanolamine sulpho-betaines); ampholytic surfactants; semi-polar non-ionic surfactants and mixtures thereof.

The composition can be a detergent composition, optionally including, for example, a surfactancy boosting polymer consisting of amphiphilic alkoxylated grease cleaning polymers. Suitable amphiphilic alkoxylated grease cleaning polymers can include, for example, alkoxylated polymers having branched hydrophilic and hydrophobic properties, such as alkoxylated polyalkylenimines, random graft polymers comprising a hydrophilic backbone comprising monomers, for example, unsaturated C₁-C₆ carboxylic acids, ethers, alcohols, aldehydes, ketones, esters, sugar units, alkoxy units, maleic anhydride, saturated polyalcohols such as glycerol, and mixtures thereof; and hydrophobic side chain(s), for example, one or more C₄-C₂₅ alkyl groups, polypropylene, polybutylene, vinyl esters of saturated C₁-C₆ mono-carboxylic acids, C₁-C₆ alkyl esters of acrylic or methacrylic acid, and mixtures thereof.

Suitable heavy duty laundry detergent compositions can optionally include additional polymers such as soil release polymers (include anionically end-capped polyesters, for example SRP1, polymers comprising at least one monomer unit selected from saccharide, dicarboxylic acid, polyol and combinations thereof, in random or block configuration, ethylene terephthalate-based polymers and co-polymers thereof in random or block configuration, for example REPEL-O-TEX SF, SF-2 AND SRP6, TEXCARE SRA100, SRA300, SRN100, SRN170, SRN240, SRN300 AND SRN325, MARLOQUEST SL), anti-redeposition polymers, include carboxylate polymers, such as polymers comprising at least one monomer selected from acrylic acid, maleic acid (or maleic anhydride), fumaric acid, itaconic acid, aconitic acid, mesaconic acid, citraconic acid, methylenemalonic acid, and any mixture thereof, vinylpyrrolidone homopolymer, and/or polyethylene glycol, molecular weight in the range of from 500 to 100,000 Daltons (Da); and polymeric carboxylate (such as maleate/acrylate random copolymer or polyacrylate homopolymer). If present, soil release polymers can be included at 0.1 to 10% by weight, based on the total weight of the composition.

The heavy duty laundry detergent composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic starch, cationic polyacylamides or a combination thereof. If present, the fatty acids and/or the deposition aids can each be present at 0.1% to 10% by weight, based on the total weight of the composition.

The detergent composition may optionally include silicone or fatty-acid based suds suppressors; hueing dyes, calcium and magnesium cations, visual signaling ingredients, anti-foam (0.001% to about 4.0% by weight, based on the total weight of the composition), and/or a structurant/thickener (0.01% to 5% by weight, based on the total weight of the composition) selected from the group consisting of diglycerides and triglycerides, ethylene glycol distearate, microcrystalline cellulose, microfiber cellulose, biopolymers, xanthan gum, gellan gum, and mixtures thereof).

The compositions disclosed herein can be in the form of a dishwashing detergent composition. Examples of dishwashing detergents include automatic dishwashing detergents (typically used in dishwasher machines) and hand-washing dish detergents. A dishwashing detergent composition can be in any dry or liquid/aqueous form as disclosed herein, for example. Components that may be included in certain embodiments of a dishwashing detergent composition include, for example, one or more of a phosphate; oxygen-or chlorine-based bleaching agent; non-ionic surfactant; alkaline salt (e.g., metasilicates, alkali metal hydroxides, sodium carbonate); any active enzyme disclosed herein; anti-corrosion agent (e.g., sodium silicate); anti-foaming agent; additives to slow down the removal of glaze and patterns from ceramics; perfume; anti-caking agent (in granular detergent); starch (in tablet-based detergents); gelling agent (in liquid/gel based detergents); and/or sand (powdered detergents).

In addition to the polysaccharide derivative, dishwashing detergent compositions can comprise (i) a non-ionic surfactant, including any ethoxylated non-ionic surfactant, alcohol alkoxylated surfactant, epoxy-capped poly(oxyalkylated) alcohol, or amine oxide surfactant present in an amount from 0 to 10% by weight; (ii) a builder, in the range of about 5 to 60% by weight, including any phosphate builder (e.g., mono-phosphates, di-phosphates, tri-polyphosphates, other oligomeric-polyphosphates, sodium tripolyphosphate-STPP), any phosphate-free builder (e.g., amino acid-based compounds including methyl-glycine-diacetic acid [MGDA] and salts or derivatives thereof, glutamic-N,N-diacetic acid [GLDA] and salts or derivatives thereof, iminodisuccinic acid (IDS) and salts or derivatives thereof, carboxy methyl inulin and salts or derivatives thereof, nitrilotriacetic acid [NTA], diethylene triamine penta acetic acid [DTPA], B-alaninediacetic acid [B-ADA] and salts thereof), homopolymers and copolymers of poly-carboxylic acids and partially or completely neutralized salts thereof, monomeric polycarboxylic acids and hydroxycarboxylic acids and salts thereof in the range of 0.5 to 50% by weight, or sulfonated/carboxylated polymers in the range of about 0.1% to about 50% by weight; (iii) a drying aid in the range of about 0.1% to about 10% by weight (e.g., polyesters, especially anionic polyesters, optionally together with further monomers with 3 to 6 functionalities, for example, acid, alcohol or ester functionalities which are conducive to polycondensation, polycarbonate-, polyurethane- and/or polyurea-polyorganosiloxane compounds or precursor compounds thereof, particularly of the reactive cyclic carbonate and urea type); (iv) a silicate in the range from about 1% to about 20% by weight (e.g., sodium or potassium silicates such as sodium disilicate, sodium meta-silicate and crystalline phyllosilicates); (v) an inorganic bleach (e.g., perhydrate salts such as perborate, percarbonate, perphosphate, persulfate and persilicate salts) and/or an organic bleach, for example, organic peroxyacids such as diacyl- and tetraacylperoxides, especially diperoxydodecanedioic acid, diperoxytetradecanedioic acid, and diperoxyhexadecanedioic acid; (vi) a bleach activator, for example, organic peracid precursors in the range from about 0.1% to about 10% by weight and/or bleach catalyst (e.g., manganese triazacyclononane and related complexes; Co, Cu, Mn, and Fe bispyridylamine and related complexes; and pentamine acetate cobalt (III) and related complexes); (vii) a metal care agent in the range from about 0.1% to 5% by weight, for example, benzatriazoles, metal salts and complexes, and/or silicates; and/or (viii) any active enzyme disclosed herein in the range from about 0.01 to 5.0 mg of active enzyme per gram of automatic dishwashing detergent composition, and an enzyme stabilizer component. The percentages by weight are based on the total weight of the composition.

Various examples of detergent formulations comprising at least one polysaccharide derivative as disclosed herein are disclosed below (1-21):

1) A detergent composition formulated as a granulate having a bulk density of at least 600 g/L comprising: linear alkylbenzenesulfonate (calculated as acid) at about 7 to 12% by weight; alcohol ethoxysulfate (e.g., C12-18 alcohol, 1-2 ethylene oxide [EO]) or alkyl sulfate (e.g., C16-18) at about 1 to 4% by weight; alcohol ethoxylate (e.g., C14-15 alcohol) at about 5 to 9% by weight; sodium carbonate at about 14 to 20% by weight; soluble silicate (e.g., Na₂O 2SiO₂) at about 2 to 6% by weight; zeolite (e.g., NaAlSiO₄) at about 15 to 22% by weight; sodium sulfate at about 0 to 6% by weight; sodium citrate/citric acid at about 0 to 15% by weight; sodium perborate at about 11 to 18% by weight; TAED at about 2 to 6% by weight; polysaccharide derivative up to about 2% by weight; other polymers (e.g., maleic/acrylic acid copolymer, PVP, PEG) at about 0 to 3% by weight; optionally an enzyme(s) (calculated as pure enzyme protein) at about 0.0001 to 0.1% by weight; and minor ingredients (e.g., suds suppressors, perfumes, optical brightener, photobleach) at about 0 to 5% by weight.

2) A detergent composition formulated as a granulate having a bulk density of at least 600 g/L comprising: linear alkylbenzenesulfonate (calculated as acid) at about 6 to 11% by weight; alcohol ethoxysulfate (e.g., C12-18 alcohol, 1-2 EO) or alkyl sulfate (e.g., C16-18) at about 1 to 3% by weight; alcohol ethoxylate (e.g., C14-15 alcohol) at about 5 to 9% by weight; sodium carbonate at about 15 to 21% by weight; soluble silicate (e.g., Na₂O 2SiO₂) at about 1 to 4% by weight; zeolite (e.g., NaAlSiO₄) at about 24 to 34% by weight; sodium sulfate at about 4 to 10% by weight; sodium citrate/citric acid at about 0 to 15% by weight; sodium perborate at about 11 to 18% by weight; TAED at about 2 to 6% by weight; polysaccharide derivative up to about 2% by weight; other polymers (e.g., maleic/acrylic acid copolymer, PVP, PEG) at about 1 to 6% by weight; optionally an enzyme(s) (calculated as pure enzyme protein) at about 0.0001 to 0.1% by weight; and minor ingredients (e.g., suds suppressors, perfumes, optical brightener, photobleach) at about 0 to 5% by weight.

3) A detergent composition formulated as a granulate having a bulk density of at least 600 g/L comprising: linear alkylbenzenesulfonate (calculated as acid) at about 5 to 9% by weight; alcohol ethoxysulfate (e.g., C12-C18 alcohol, 7 EO) at about 7 to 14% by weight; soap as fatty acid (e.g., C16-C22 fatty acid) at about 1 to 3% by weight; sodium carbonate at about 10 to 17% by weight; soluble silicate (e.g., Na₂O 2SiO₂) at about 3 to 9% by weight; zeolite (e.g., NaAlSiO₄) at about 23 to 33% by weight; sodium sulfate at about 0 to 4% by weight; sodium perborate at about 8 to 16% by weight; TAED at about 2 to 8% by weight; phosphonate (e.g., EDTMPA) at about 0 to 1% by weight; polysaccharide derivative up to about 2% by weight; other polymers (e.g., maleic/acrylic acid copolymer, PVP, PEG) at about 0 to 3% by weight; optionally an enzyme(s) (calculated as pure enzyme protein) at about 0.0001 to 0.1% by weight; and minor ingredients (e.g., suds suppressors, perfumes, optical brightener) at about 0 to 5% by weight.

4) A detergent composition formulated as a granulate having a bulk density of at least 600 g/L comprising: linear alkylbenzene sulfonate (calculated as acid) at about 8 to 12% by weight; alcohol ethoxylate (e.g., C12-18 alcohol, 7 EO) at about 10 to 25% by weight; sodium carbonate at about 14 to 22% by weight; soluble silicate (e.g., Na₂O 2SiO₂) at about 1 to 5% by weight; zeolite (e.g., NaAlSiO₄) at about 25 to 35% by weight; sodium sulfate at about 0 to 10% by weight; sodium perborate at about 8 to 16% by weight; TAED at about 2 to 8% by weight; phosphonate (e.g., EDTMPA) at about 0 to 1% by weight; polysaccharide derivative up to about 2% by weight; other polymers (e.g., maleic/acrylic acid copolymer, PVP, PEG) at about 1 to 3% by weight; optionally an enzyme(s) (calculated as pure enzyme protein) at about 0.0001 to 0.1% by weight; and minor ingredients (e.g., suds suppressors, perfumes) at about 0 to 5% by weight.

5) An aqueous liquid detergent composition comprising: linear alkylbenzenesulfonate (calculated as acid) at about 15 to 21% by weight; alcohol ethoxylate (e.g., C12-18 alcohol, 7 EO; or C12-15 alcohol, 5 EO) at about 12 to 18% by weight; soap as fatty acid (e.g., oleic acid) at about 3 to 13% by weight; alkenylsuccinic acid (C12-14) at about 0 to 13% by weight; aminoethanol at about 8 to 18% by weight; citric acid at about 2 to 8% by weight; phosphonate at about 0 to 3% by weight; polysaccharide derivative up to about 2% by weight; other polymers (e.g., PVP, PEG) at about 0 to 3% by weight; borate at about 0 to 2% by weight; ethanol at about 0 to 3% by weight; propylene glycol at about 8 to 14% by weight; optionally an enzyme(s) (calculated as pure enzyme protein) at about 0.0001 to 0.1% by weight; and minor ingredients (e.g., dispersants, suds suppressors, perfume, optical brightener) at about 0 to 5% by weight.

6) An aqueous structured liquid detergent composition comprising: linear alkylbenzenesulfonate (calculated as acid) at about 15 to 21% by weight; alcohol ethoxylate (e.g., C12-18 alcohol, 7 EO; or C12-15 alcohol, 5 EO) at about 3 to 9% by weight; soap as fatty acid (e.g., oleic acid) at about 3 to 10% by weight; zeolite (e.g., NaAlSiO₄) at about 14 to 22% by weight; potassium citrate about 9 to 18% by weight; borate at about 0 to 2% by weight; polysaccharide derivative up to about 2% by weight; other polymers (e.g., PVP, PEG) at about 0 to 3% by weight; ethanol at about 0 to 3% by weight; anchoring polymers (e.g., lauryl methacrylate/acrylic acid copolymer, molar ratio 25:1, MW 3800) at about 0 to 3% by weight; glycerol at about 0 to 5% by weight; optionally an enzyme(s) (calculated as pure enzyme protein) at about 0.0001 to 0.1% by weight; and minor ingredients (e.g., dispersants, suds suppressors, perfume, optical brightener) at about 0 to 5% by weight.

7) A detergent composition formulated as a granulate having a bulk density of at least 600 g/L comprising: fatty alcohol sulfate at about 5 to 10% by weight, ethoxylated fatty acid monoethanolamide at about 3 to 9% by weight; soap as fatty acid at about 0 to 3% by weight; sodium carbonate at about 5 to 10% by weight; soluble silicate (e.g., Na₂O 2SiO₂) at about 1 to 4% by weight; zeolite (e.g., NaAlSiO₄) at about 20 to 40% by weight; sodium sulfate at about 2 to 8% by weight; sodium perborate at about 12 to 18% by weight; TAED at about 2 to 7% by weight; polysaccharide derivative up to about 2% by weight; other polymers (e.g., maleic/acrylic acid copolymer, PEG) at about 1 to 5% by weight; optionally an enzyme(s) (calculated as pure enzyme protein) at about 0.0001 to 0.1% by weight; and minor ingredients (e.g., optical brightener, suds suppressors, perfumes) at about 0 to 5% by weight.

8) A detergent composition formulated as a granulate comprising: linear alkylbenzenesulfonate (calculated as acid) at about 8 to 14% by weight; ethoxylated fatty acid monoethanolamide at about 5 to 11% by weight; soap as fatty acid at about 0 to 3% by weight; sodium carbonate at about 4 to 10% by weight; soluble silicate (e.g., Na₂O 2SiO₂) at about 1 to 4% by weight; zeolite (e.g., NaAlSiO₄) at about 30 to 50% by weight; sodium sulfate at about 3 to 11% by weight; sodium citrate at about 5 to 12% by weight; polysaccharide derivative up to about 2% by weight; other polymers (e.g., PVP, maleic/acrylic acid copolymer, PEG) at about 1 to 5% by weight; optionally an enzyme(s) (calculated as pure enzyme protein) at about 0.0001 to 0.1% by weight; and minor ingredients (e.g., suds suppressors, perfumes) at about 0 to 5% by weight.

9) A detergent composition formulated as a granulate comprising: linear alkylbenzenesulfonate (calculated as acid) at about 6 to 12% by weight; nonionic surfactant at about 1 to 4% by weight; soap as fatty acid at about 2 to 6% by weight; sodium carbonate at about 14 to 22% by weight; zeolite (e.g., NaAlSiO₄) at about 18 to 32% by weight; sodium sulfate at about 5 to 20% by weight; sodium citrate at about 3 to 8% by weight; sodium perborate at about 4 to 9% by weight; bleach activator (e.g., NOBS or TAED) at about 1 to 5% by weight; polysaccharide derivative up to about 2% by weight; other polymers (e.g., polycarboxylate or PEG) at about 1 to 5% by weight; optionally an enzyme(s) (calculated as pure enzyme protein) at about 0.0001 to 0.1% by weight; and minor ingredients (e.g., optical brightener, perfume) at about 0 to 5% by weight.

10) An aqueous liquid detergent composition comprising: linear alkylbenzenesulfonate (calculated as acid) at about 15 to 23% by weight; alcohol ethoxysulfate (e.g., C₁₂₋₁₅ alcohol, 2-3 EO) at about 8 to 15% by weight; alcohol ethoxylate (e.g., C₁₂₋₁₅ alcohol, 7 EO; or C₁₂₋₁₅ alcohol, 5 EO) at about 3 to 9% by weight; soap as fatty acid (e.g., lauric acid) at about 0 to 3% by weight; aminoethanol at about 1 to 5% by weight; sodium citrate at about 5 to 10% by weight; hydrotrope (e.g., sodium cumene sulfonate) at about 2 to 6% by weight; borate at about 0 to 2% by weight; polysaccharide derivative up to about 1% by weight; ethanol at about 1 to 3% by weight; propylene glycol at about 2 to 5% by weight; optionally an enzyme(s) (calculated as pure enzyme protein) at about 0.0001 to 0.1% by weight; and minor ingredients (e.g., dispersants, perfume, optical brighteners) at about 0 to 5% by weight.

11) An aqueous liquid detergent composition comprising: linear alkylbenzenesulfonate (calculated as acid) at about 20 to 32% by weight; alcohol ethoxylate (e.g., C12-15 alcohol, 7 EO; or C12-15 alcohol, 5 EO) at about 6 to 12% by weight; aminoethanol at about 2 to 6% by weight; citric acid at about 8 to 14% by weight; borate at about 1 to 3% by weight; polysaccharide derivative up to about 2% by weight; ethanol at about 1 to 3% by weight; propylene glycol at about 2 to 5% by weight; other polymers (e.g., maleic/acrylic acid copolymer, anchoring polymer such as lauryl methacrylate/acrylic acid copolymer) at about 0 to 3% by weight; glycerol at about 3 to 8% by weight; optionally an enzyme(s) (calculated as pure enzyme protein) at about 0.0001 to 0.1% by weight; and minor ingredients (e.g., hydrotropes, dispersants, perfume, optical brighteners) at about 0 to 5% by weight.

12) A detergent composition formulated as a granulate having a bulk density of at least 600 g/L comprising: anionic surfactant (e.g., linear alkylbenzenesulfonate, alkyl sulfate, alpha-olefinsulfonate, alpha-sulfo fatty acid methyl esters, alkanesulfonates, soap) at about 25 to 40% by weight; nonionic surfactant (e.g., alcohol ethoxylate) at about 1 to 10% by weight; sodium carbonate at about 8 to 25% by weight; soluble silicate (e.g., Na2O 2SiO2) at about 5 to 15% by weight; sodium sulfate at about 0 to 5% by weight; zeolite (NaAlSiO₄) at about 15 to 28% by weight; sodium perborate at about 0 to 20% by weight; bleach activator (e.g., TAED or NOBS) at about 0 to 5% by weight; polysaccharide derivative up to about 2% by weight; optionally an enzyme(s) (calculated as pure enzyme protein) at about 0.0001 to 0.1% by weight; and minor ingredients (e.g., perfume, optical brighteners) at about 0 to 3% by weight. 13) Detergent compositions as described in (1)-(12) above, but in which all or part of the linear alkylbenzenesulfonate is replaced by C12-C18 alkyl sulfate.

14) A detergent composition formulated as a granulate having a bulk density of at least 600 g/L comprising: C12-C18 alkyl sulfate at about 9 to 15% by weight; alcohol ethoxylate at about 3 to 6% by weight; polyhydroxy alkyl fatty acid amide at about 1 to 5% by weight; zeolite (e.g., NaAlSiO₄) at about 10 to 20% by weight; layered disilicate (e.g., SK56 from Hoechst) at about 10 to 20% by weight; sodium carbonate at about 3 to 12% by weight; soluble silicate (e.g., Na₂O 2SiO₂) at 0 to 6% by weight; sodium citrate at about 4 to 8% by weight; sodium percarbonate at about 13 to 22% by weight; TAED at about 3 to 8% by weight; polysaccharide derivative up to about 2% by weight; other polymers (e.g., polycarboxylates and PVP) at about 0 to 5% by weight; optionally an enzyme(s) (calculated as pure enzyme protein) at about 0.0001 to 0.1% by weight; and minor ingredients (e.g., optical brightener, photobleach, perfume, suds suppressors) at about 0 to 5% by weight.

15) A detergent composition formulated as a granulate having a bulk density of at least 600 g/L comprising: C12-C18 alkyl sulfate at about 4 to 8% by weight; alcohol ethoxylate at about 11 to 15% by weight; soap at about 1 to 4% by weight; zeolite MAP or zeolite A at about 35 to 45% by weight; sodium carbonate at about 2 to 8% by weight; soluble silicate (e.g., Na₂O 2SiO₂) at 0 to 4% by weight; sodium percarbonate at about 13 to 22% by weight; TAED at about 1 to 8% by weight; polysaccharide derivative up to about 3% by weight; other polymers (e.g., polycarboxylates and PVP) at about 0 to 3% by weight; optionally an enzyme(s) (calculated as pure enzyme protein) at about 0.0001 to 0.1% by weight; and minor ingredients (e.g., optical brightener, phosphonate, perfume) at about 0 to 3% by weight.

16) Detergent formulations as described in (1) to (15) above, but that contain a stabilized or encapsulated peracid, either as an additional component or as a substitute for an already specified bleach system(s).

17) Detergent compositions as described in (1), (3), (7), (9) and (12) above, but in which perborate is replaced by percarbonate.

18) Detergent compositions as described in (1), (3), (7), (9), (12), (14) and (15) above, but that additionally contain a manganese catalyst. A manganese catalyst, for example, is one of the compounds described by Hage et al. (1994, Nature 369:637-639), which is incorporated herein by reference.

19) Detergent compositions formulated as a non-aqueous detergent liquid comprising a liquid non-ionic surfactant, for example, a linear alkoxylated primary alcohol, a builder system (e.g., phosphate), polysaccharide derivative, optionally an enzyme(s), and alkali. The detergent may also comprise an anionic surfactant and/or bleach system. 20) An aqueous liquid detergent composition comprising: non-petroleum-derived alcohol ethoxysulfate (e.g., C12 alcohol, 1 EO) sodium sulfate at about 30 to 45% by weight; non-petroleum-derived alcohol ethoxylate (e.g., C12-14 alcohol, 9 EO) at about 3 to 10% by weight; soap as fatty acid (e.g., C12-18) at about 1 to 5% by weight; propylene glycol at about 5-12% by weight; C12-14 alkyl amineoxide at about 4 to 8% by weight; citric acid at about 2 to 8% by weight; polysaccharide derivative up to about 4% by weight; other polymers (e.g., PVP, PEG) at about 0 to 3% by weight; borate at about 0 to 4% by weight; ethanol at about 0 to 3% by weight; optionally an enzyme(s) (calculated as pure enzyme protein) at about 0.0001 to 0.3% by weight; and minor ingredients (e.g., dispersants, suds suppressors, perfume, optical brightener, stabilizers) at about 0 to 5% by weight and the balance being water.

21) A water-soluble unit dose detergent composition comprising: alcohol ethoxysulfate (e.g., C12-15 alcohol, 2-3 EO) sodium sulfate at about 10 to 25% by weight; linear alkylbenzenesulfonate (calculated as acid) at about 15 to 25% by weight; alcohol ethoxylate (e.g., C12-14 alcohol, 9 EO) at about 0.5 to 10% by weight; alcohol ethoxylate (e.g., C12-15 alcohol, 7 EO) at about 0.5 to 10% by weight; soap as fatty acid (e.g., C12-18) at about 1 to 8% by weight; propylene glycol at about 6 to 15% by weight; citric acid at about 0.5 to 8% by weight; polysaccharide derivative up to about 4% by weight; monoethanolamine at about 5 to 10% by weight, other polymers (e.g., PVP, PEG, PVOH) at about 0 to 3% by weight; dipropyleneglycol at about 2 to 6%, glycerine at about 2 to 5% by weight; optionally an enzyme(s) (calculated as pure enzyme protein) at about 0.0001 to 0.3% by weight; and minor ingredients (e.g., dispersants, suds suppressors, perfume, optical brightener, stabilizers) at about 0 to 5% by weight and the balance being water.

Various examples of personal care formulations comprising at least one polysaccharide derivative are disclosed below (22-24)

22) A hair conditioner composition comprising: cetyl alcohol (1-3%), isopropyl myristate (1-3%), hydroxyethyl cellulose (Natrosol® 250 HHR), 0.1-1%, polysaccharide derivative of the present invention (0.1-2%), potassium salt (0.1-0.5%), Preservative, Germaben® II (0.5%) available from International Specialty Products), and the balance being water.

23) A hair shampoo composition comprising: 5-20% sodium laureth sulfate, 1-2wt % cocamidopropyl betane, 1-2 wt % sodium chloride, 0.1-2% polysaccharide derivative of the present invention, and Preservative (0.1-0.5%), and the balance being water. 24) A skin lotion composition comprising: 1-5% glycerin, 1-5% glycol stearate, 1-5% stearic acid, 1-5% mineral oil, 0.5-1% acetylated lanolin (Lipolan® 98), 0.1-0.5 cetyl alcohol, 0.2-1% triethanolamine, 0.1-1 wt % Germaben® II preservative, 0.5-2wt % polysaccharide derivatives of the present invention, and the balance being water.

In some embodiments, compositions comprising the polysaccharide derivative can be used directly in a variety of processes, for example to cast a film, coat a substrate, or spin fibers. Films comprising the polysaccharide derivative can be cast by methods known in the art. For film casting or extrusion, the solution viscosity of a composition comprising the polysaccharide derivative should be low enough to be flowable and processable, but high enough to form a continuous film without breaking up. The concentration of the polysaccharide derivative in solution to achieve these viscosities may range from about 8 wt % to about 30 wt %.

The films may be produced by casting the solution onto a substrate using a rod coater or a draw down coater but can also be produced by other solution film casting methods such as extrusion through a slot die. Film casting is carried out by using casting techniques known to those skilled in the art. This includes pouring the solution on a support, and spreading the solution onto the support using a casting rod such as a Meyer rod or a doctor blade. The substrates include but are not limited to glass (coated with surfactant or without) and polyester films. Residual solvent can be removed by drying the film, for example in air at or above ambient temperature, or under a stream of inert gas. The film may be dried under tension to form a free-standing film.

In one embodiment, compositions comprising a polysaccharide derivative as disclosed herein can be used to coat substrates, for example metal, paper, or plastic substrates. In some embodiments, the substrate can be a fibrous substrate such as fabrics, for example to provide clothing which has good water impermeability and improved comfort for the wearer. In one embodiment, a coated fibrous substrate comprises a fibrous substrate having a surface, wherein the surface comprises a coating comprising a polysaccharide derivative as disclosed herein, optionally in combination with a polymer, on at least a portion of the surface.

Fibrous substrates can include fibers, yarns, fabrics, fabric blends, textiles, nonwovens, paper, leather, and carpets. In one embodiment, the fibrous substrate is a fiber, a yarn, a fabric, a textile, or a nonwoven. The fibrous substrates can contain natural or synthetic fibers, including cotton, cellulose, wool, silk, rayon, nylon, aramid, acetate, polyurethaneurea, acrylic, jute, sisal, sea grass, coir, polyamide, polyester, polyolefin, polypropylene, polyaramid, or blends thereof. By “fabric blends” is meant fabric made of two or more types of fibers. Typically, these blends are a combination of at least one natural fiber and at least one synthetic fiber, but also can include a blend of two or more natural fibers or of two or more synthetic fibers. Nonwoven substrates include, for example, spun-laced nonwovens such as SONTARA® available from DuPont and spun-bonded-meltblown-spunbonded nonwovens.

A substrate can be coated by a method comprising the steps:

(i) providing a solution of a coating composition comprising solvent and a polysaccharide derivative as disclosed herein;

(ii) applying a layer of the solution of coating composition to at least a portion of at least one surface of the substrate; and

(iii) removing at least a portion of the solvent from the applied layer to form a dried layer of coating composition.

The coating composition can be prepared by adding the polysaccharide derivative to a suitable organic solvent and agitating until a solution forms. Suitable solvents can include dimethyl sulfoxide, dimethyl acetamide, dimethyl formamide, pyridine, 2-methyl-pyrrolidinone, or a combination thereof. The polysaccharide derivative can be present in the range of from 0.1 to 40% by weight, based on the total weight of the coating composition solution. In one embodiment the polysaccharide derivative can be present in the range of from 5 to 30% by weight, based on the total weight of the coating composition solution. other embodiments, the polysaccharide derivative can be present in the coating composition solution in the range of from 1 to 30% or 2 to 25% or 2 to 20% by weight, wherein the percentage by weight is based on the total weight of the coating composition solution.

In any given embodiment, the solubility limit of the polysaccharide derivative in the solvent is a function of the molecular weight of the polysaccharide derivative, the duration of mixing, the viscosity of the solution as it is being formed, the shear forces to which the solution is subject, and the temperature at which mixing takes place. In general, lower molecular weight polysaccharide derivatives will be more soluble than the corresponding higher molecular weight analogues, other things being equal. In general, more highly substituted polysaccharide derivatives become more soluble, both in increasing the solids loading in a solvent as well as being soluble in a wider range of solvents, than the corresponding lower substituted analogues, other things being equal. Generally, higher shear mixing, longer mixing time, and higher temperature will be associated with higher solubility. The maximum temperature for mixing is limited by the boiling point of the solvent used.

If desired, additives and/or binders can be added at any point of the process of forming the solution of coating composition. The additives can be dispersed and/or dissolved in the solvent before the polysaccharide derivative is added, during the addition of the polysaccharide derivative, or after the addition of the polysaccharide derivative.

The layer of coating composition can be applied to at least a portion of the substrate. The layer can be applied via any method known in the art, for example, air knife coating, rod coating, bar coating, wire bar coating, spray coating, brush coating, cast coating, flexible blade coating, gravure coating, jet applicator coating, short dwell coating, slide hopper coating, curtain coating, flexographic coating, size-press coating, reverse roll coating, and transfer roll coating. The solution of coating composition can be applied on at least a portion of the substrate, for example, on a single side or both sides of the substrate, a portion of a single side, or a portion of both sides of a flat substrate. The solution of coating composition can be applied once to the substrate or multiple times to the substrate.

After application of the coating composition solution to at least a portion of the substrate, at least a portion of the solvent can be removed to produce a continuous layer of coating composition. The solvent can be removed by evaporation, heating, or a combination thereof. For example, air or convection drying, linear tunnel drying, arc drying, air-loop drying, contact or conduction drying, radiant energy drying, infrared drying, microwave drying, or a combination thereof may be used. The coated substrate can optionally be calendared after drying in order to improve the surface smoothness and gloss. Calendaring can be carried out by passing the coated substrate through nips and rollers one or more times.

In another embodiment, a composition comprising the polysaccharide derivative further comprises a polymer. The polysaccharide derivative can be combined with a polymer, wherein the polymer is optionally dispersed in or dissolved in a solvent.

Polymers suitable for blending with the polysaccharide derivative may include, for example, polyacrylates, polyaramids, polyphenylene isophthalamide, poly-m-phenylene isophthalamide, polyphenylene terephthalamide, vinyl polymers, polyethylene, polypropylene, poly(vinyl chloride), polystyrene, polytetrafluoroethylene, poly(alpha-methylstyrene), poly(acrylic acid), poly(isobutylene), poly(methacrylic acid), poly(methyl methacrylate), poly(1-pentene), poly(1,3-butadiene), poly(vinyl acetate), poly(2-vinyl pyridine), 1,4-polyisoprene, 3,4-polychloroprene, polyethers, poly(ethylene oxide), poly(propylene oxide), poly(trimethylene glycol), poly(tetramethylene glycol), polyacetals, polyformaldehyde, polyacetaldehyde, polyesters, poly(3-propionate), poly(10-decanoate), poly(ethylene terephthalate), poly(m-phenylene terephthalate); polyamides, polycaprolactam, poly(11-undecanoamide), poly(hexamethylene sebacamide), poly(tetramethylene-m-benzenesulfonamide), polyetheretherketone, polyetherimide, poly(phenylene oxide), polyamide (including polyureas), polyamideimide, polyarylate, polybenzimidazole, polycarbonates, polyurethane, polyimide, polyhydrazide, phenolic resins, polysilane, polysiloxane, polycarbodiimide, polyimine, azo polymers, polysulfide, polysulfane, cellulose polymers, or starch polymers. In some embodiments, the polysaccharide derivative can be blended with starch, cellulose including various esters, ethers, and graft copolymers thereof, polyphenylene isophthalamide, or polyphenylene terephthalamide. The one or more polymers may be crosslinkable in the presence of a multifunctional crosslinking agent or crosslinkable upon exposure to actinic radiation or other type of radiation. The one or more polymers may be homopolymers of any of the foregoing polymers, random copolymers, block copolymers, alternating copolymers, random terpolymers, block terpolymers, alternating terpolymers, or derivatives thereof (e.g., graft copolymers, esters, or ethers thereof).

The blends can comprise the polysaccharide derivative and the one or more polymers in a weight ratio in the range of from 0.01:99.99 to 99.99:0.01. In other embodiments, the weight ratio can be in the range of from 1:99 to 99:1, or from 5:95 to 95:5, or from 10:90 to 90:10, or from 20:80 to 80:20, or from 30:70 to 70:30, or from 40:60 to 60:40, or from 45:55 to 55:45.

Compositions comprising the polysaccharide derivative can be used to spin fibers. In one embodiment, the fibers can be spun from a composition comprising the polysaccharide derivative and an organic solvent, wherein the concentration of the polysaccharide derivative in the composition may in the range of from 5 to 30 percent by weight, for example 5 to 10, or 5 to 15, or 5 to 20, or 5 to 25, or 10 to 20, or 10 to 30, or 15 to 25, or 15 to 30, based on the total weight of the composition. Below 5 percent by weight, the fiber forming ability of the solution may be degraded while concentrations above 30 percent by weight are problematic, requiring increasingly refined techniques in order to form the fibers.

In one embodiment, the composition further comprises a polymer as disclosed herein above. The soluble blend of polymer and polysaccharide derivative can be fed directly to a spinneret and the resulting fiber quenched in a coagulation bath, for example, an acidic coagulation bath. Suitable acidic coagulants include, for example, glacial acetic acid, aqueous acetic acid, sulfuric acid, combinations of sulfuric acid, sodium sulfate, and zinc sulfate. In some embodiments, the liquid coagulant can be maintained at a temperature in the range of 0 to 100° C., and preferably in the range of 15 to 70° C. In some embodiments, extrusion is effected directly into the acidic coagulation bath. In such a circumstance, known in the art as “wet-spinning,” the spinneret is partially or fully immersed in the acidic coagulation bath. The spinnerets and associated fittings are typically constructed of corrosion resistant alloys such as stainless steel or platinum/gold. The thus coagulated fiber can then be passed into a second bath provided to neutralize and/or dilute residual acid from the first coagulation bath. The secondary bath preferably contains H₂O, methanol, or aqueous NaHCO₃, or a mixture thereof. In some embodiments, the wound fiber package can be soaked in one or more neutralizing wash baths for a period of time. A sequence of baths comprising any combinations of water, methanol or aqueous NaHCO₃ can also be used.

Any of the known methods for spinning fibers from an organic solution can be used, for example, wet spinning, dry spinning and air gap spinning are all useful methods. In each of these methods, a solution of the polymer and polysaccharide derivative is forced through a single or multi-holed spinneret or other form of a die. The spinneret holes can be of any cross-sectional shape, for example, round, flat, square, rectangular, a polygon or multi-lobed. The material can then be passed into a coagulation bath wherein the coagulation bath comprises a liquid coagulant which dissolves the solvent but not the polymer or polysaccharide derivative in order to form the desired fiber. In some embodiments, the fiber strand is first passed through an inert, noncoagulating layer, for example, air in the form of an air gap, prior to introduction into the coagulating bath. In other embodiments, the material can be extruded directly into a coagulating bath. In general, the method comprises the steps of:

1) providing a composition comprising the polysaccharide derivative, the desired polymer, and a solvent;

2) causing the composition to flow through a spinneret; and

3) removing at least a portion of the solvent from the formed fiber. The fibers can be used to produce an article. In some embodiments, the article can be a carpet, a textile, fabric, yarn, or apparel.

Non-limiting examples of the embodiments disclosed herein include:

1. A polysaccharide derivative comprising: a polysaccharide substituted with at least one carbamate group; wherein the polysaccharide comprises poly alpha-1,3-glucan, poly alpha-1,3-1,6-glucan, or a mixture thereof; and the polysaccharide derivative has a degree of substitution of about 0.001 to about 3.

2. The polysaccharide derivative of embodiment 1, wherein the polysaccharide comprises poly alpha-1,3-glucan, and the poly alpha-1,3-glucan comprises a backbone of glucose monomer units wherein greater than or equal to 50% of the glucose monomer units are linked via alpha-1,3-glycosidic linkages.

3. The polysaccharide derivative of embodiment 1, wherein the polysaccharide comprises alpha-1,3-glucan, and the poly alpha-1,3-glucan comprises a backbone of glucose monomer units wherein greater than or equal to 90% of the glucose monomer units are linked via alpha-1,3-glycosidic linkages.

4. The polysaccharide derivative of embodiment 1, wherein the polysaccharide comprises poly alpha-1,3-1,6-glucan, wherein (i) at least 30% of the glycosidic linkages of the poly alpha-1,3-1,6-glucan are alpha-1,3 linkages, (ii) at least 30% of the glycosidic linkages of the poly alpha-1,3-1,6-glucan are alpha-1,6 linkages, (iii) the poly alpha-1,3-1,6-glucan has a weight average degree of polymerization (DP_{w}) of at least 10; and (iv) the alpha-1,3 linkages and alpha-1,6 linkages of the poly alpha-1,3-1,6-glucan do not consecutively alternate with each other.

5. The polysaccharide derivative of embodiment 1, 2, 3, or 4, having a degree of polymerization in the range of from about 5 to about 1400.

6. The polysaccharide derivative of embodiment 1, 2, 3, 4, or 5, wherein at least one carbamate group is derived from an aliphatic, cycloaliphatic, or aromatic monoisocyanate.

7. The polysaccharide derivative of embodiment 1, 2, 3, 4, 5, or 6, wherein the at least one carbamate group is a phenyl carbamate group.

8. A composition comprising a polysaccharide derivative of embodiment 1, 2, 3, 4, 5, 6, or 7.

9. The composition of embodiment 8, further comprising a solvent.

10. The composition of embodiment 9, wherein the solvent comprises dimethyl sulfoxide, dimethyl acetamide, dimethyl formamide, pyridine, 1-methyl-2-pyrrolidinone, or a combination thereof.

11. The composition of embodiment 8, 9, or 10, further comprising at least one polymer.

12. The composition of embodiment 11, wherein the at least one polymer comprises polyacrylate, polyaramid, polyphenylene isophthalamide, poly-m-phenylene isophthalamide, polyphenylene terephthalamide, vinyl polymer, polyethylene, polypropylene, poly(vinyl chloride), polystyrene, polytetrafluoroethylene, poly(alpha-methylstyrene), poly(acrylic acid), poly(isobutylene), poly(methacrylic acid), poly(methyl methacrylate), poly(l-pentene), poly(l,3-butadiene), poly(vinyl acetate), poly(2-vinyl pyridine), 1,4-polyisoprene, 3,4-polychloroprene, polyether, poly(ethylene oxide), poly(propylene oxide), poly(trimethylene glycol), poly(tetramethylene glycol), polyacetal, polyformaldehyde, polyacetaldehyde, polyesters, poly(3-propionate), poly(10-decanoate), poly(ethylene terephthalate), poly(m-phenylene terephthalate); polyamide, polycaprolactam, poly(11-undecanoamide), poly(hexamethylene sebacamide), poly(tetramethylene-m-benzenesulfonamide), polyetheretherketone, polyetherimide, poly(phenylene oxide), polyamideimide, polyarylate, polybenzimidazole, polycarbonate, polyurethane, polyimide, polyhydrazide, phenolic resin, polysilane, polysiloxane, polycarbodiimide, polyimine, azo polymer, polysulfide, polysulfane, cellulose polymers, starch polymers, or combinations thereof.

13. A fiber, film, or coating comprising a polysaccharide derivative of embodiment 1, 2, 3, 4, 5, 6, or 7.

14. A fiber, film, or coating comprising a composition of embodiment 8, 9, 10, 11, or 12.

15. An article comprising a fiber, film, or coating of embodiment 13 or 14.

16. An article of embodiment 15, wherein the article is yarn, a fabric, a garment, apparel, a textile, carpet, packaging, or a label.

### EXAMPLES

Unless otherwise noted, all materials were used as received.

As used herein, “Comp. Ex.” Means Comparative Example; “Ex.” means Example; “g” means gram(s); “eq” means equivalent(s); “rpm” means revolutions per minute; “min” means minute(s); “μm” means microns; “cm” means centimeter; “kg” means kilogram(s); “lb” means pounds; “ppm” means parts per million.

### Materials

Dimethylacetamide (DMAc), reagent grade, was obtained from Fisher Chemical. Calcium chloride dihydrate, certified ACS grade, was obtained from Fisher Chemical. Phenylisocyanate, >99%, was obtained from Sigma Aldrich.

### Representative Preparation of Poly Alpha-1,3-Glucan

Poly alpha-1,3-glucan can be prepared using a gtfJ enzyme preparation as described in U.S. Pat. No. 7,000,000; U.S. Patent Appl. Publ. No. 2013/0244288, now U.S. Patent No. 9,080, 195; and U.S. Patent Appl. Publ. No. 2013/0244287, now U.S. Pat. No. 8,642,757 (all of which are incorporated herein by reference in their entirety).

Poly alpha-1,3-glucan polymer can be synthesized following the procedures disclosed in U.S. Appl. Publ. No. 2014/0179913, now U.S. Pat. No. 9,139,718 (see Example 12 therein, for example), both of which are incorporated herein by reference in their entirety.

Dry glucan powder typically contains 10-15% water. For the following Examples, it was ground to a d50 of 20 microns and was then dried under vacuum at 65° C. for 16 hrs. The water content was then <1%.

### Methods

Karl-Fisher analyses were performed using a Mettler Toledo C20 Coulometric KF Titrator. The fluid used was Aquastar Coulomat A Catalog #AX1697A-1.

Reduced viscosity was determined by putting the samples into solution in a 2 wt %/vol mixture of LiCl in DMSO (dimethylsulfoxide) (20 g in 1 liter DMSO). A IRG 150 tube was used and the measurements were done at 30 C. ¹H-NMR analyses (NMR) were performed by dissolving the samples in deuterated DMSO/LiCI and running on a 600 kHz unit.

### Example 1

To an agitated and jacketed 1 liter resin kettle equipped with an FTIR probe were added 700 g of dimethylacetamide, 50 grams of alpha-1,3-glucan polymer with a d50 of 20 microns and a DPw of 1100, and 26 grams of calcium chloride dihydrate. While heating the contents to 75° C. over a period of 38 minutes, the glucan and calcium chloride dihydrate went into solution. Water and DMAc were then taken overhead under vacuum to dry the reactor contents; a total of 251 g was removed. The water content of the distillate was measured by Karl-Fisher analysis. Of the 6.37 g of water added with the calcium chloride dihydrate, 5.41 were removed in the distillate. After cooling the reactor contents to 50° C., 20 mL of phenylisocyanate were added. A 6° C. exotherm was observed. A rapid increase in the absorbance's recorded by the FTIR in the N-H stretch and carbonyl regions supported the formation of the carbamate. The solution was held between 50 and 54° C. for 37 minutes. The N-H and carbonyl profiles recorded by the FTIR were flat indicating that no further reaction occurred. Heat to the reactor was then turned off and vacuum was pulled to promote evaporative cooling of the reactor contents. After removing 13 g of DMAc overhead, the reactor pressure was raised back to atmospheric pressure and 485 g of the viscous contents were poured into 2 liters of agitated water. White strands formed. The product was washed 2 times in 1 liter of methanol. After drying the product overnight under vacuum at 65° C., the product was ground to pass through a 20 mesh screen, washed 2 times with 0.5 liters methanol, and then dried overnight under vacuum at 65° C.

The overall mass balance for the reaction indicated a loss of 2.58% of the contents. The liquor at the end of the reaction contained 13.3% product, determined gravimetrically using the weight of reactor contents precipitated and the dry final product. The reduced viscosity of the product was 2.49 dL/g, corresponding to a DPw of 1060. NMR analysis of the product indicated a phenyl carbamate content of 0.44 out of a possible 3.0. A 10% solution of the product in dimethylformamide was viscous, colorless, and free of particles.

### Example 2

To an agitated and jacketed 1 liter resin kettle equipped with an FTIR probe were added 700 g of dimethylacetamide and 50 grams of alpha-1,3-glucan polymer with a d50 of 20 microns. The contents were heated to 75° C. over a period of 1 hour. Water and DMAc were taken overhead under vacuum to dry the reactor contents; a total of 132 g was removed. The water content of the distillate was measured by Karl-Fisher analysis to indicate that 1.00 g water was removed. After cooling the reactor contents to 48° C., 20 mL of phenylisocyanate were added. No exotherm was observed. The solution was held between 48 and 49° C. for 21 minutes. There was no rise in the absorbance in the N—H stretch and carbonyl regions of the FTIR, indicating that no further reaction had occurred. The reactor contents were then heated to 55° C. and held there for 32 minutes. There was no indication by the FTIR that reaction was proceeding. The temperature was then raised to 61° C. and was held there for 2 hours and 46 minutes. Very slow reaction was observed over this period. The contents were then raised to 64° C. and 10 ml of phenylisocyanate were added. A slow reaction continued over the following 15 hours but the contents remained a slurry. The run was stopped and the contents discarded.

### Example 3

To an agitated and jacketed 1 liter resin kettle equipped with an FTIR probe were added 700 g of dimethylacetamide and 50 grams of alpha-1,3-glucan polymer with a d50 of 5 microns. The contents were heated to 76° C. over a period of 58 minutes. Water and DMAc were taken overhead under vacuum to dry the reactor contents. A total of 239 g was removed. The water content of the distillate was measured by Karl-Fisher analysis to indicate that 1.58 g water was removed. After heating the contents to 86 C, 20 mL of phenylisocyanate were added. A 7° C. exotherm was observed. A rapid increase in the N-H stretch and carbonyl absorbances, recorded by the FTIR, were seen. The contents were held between 91 and 95° C. for 81 minutes. After the FTIR profiles were unchanged for 20 minutes, heat to the reactor was turned off and vacuum pulled to cool the contents. After removing 64 g of DMAc overhead, the reactor pressure was raised back to atmospheric pressure and 429 g of the viscous contents were poured into 1.5 liters of agitated water, forming white strands. The product was washed in 1 liter of methanol. After drying the product overnight under vacuum at 65° C., the product was ground to pass through a 20 mesh screen, washed 2 times with 0.4 liters methanol, and then dried overnight under vacuum at 65° C.

The overall mass balance for the reaction indicated a loss of 4.17% of the contents. The liquor at the end of the reaction contained 18.3% product. The reduced viscosity of the product was 1.79 dL/g, corresponding to a DPw of 687. NMR analysis of the product indicated a phenyl carbamate content of 0.56 out of a possible 3.0. A 10% solution of the product in dimethylformamide was viscous, colorless, and cloudy. Microscopic examination of the mixture showed the presence of many angular particles which resembled that of the glucan polymer starting material to suggest a fraction of the solids did not react.

### Example 4

To an agitated and jacketed 3 liter resin kettle were added 2700 g of dimethylacetamide, 110 g of calcium chloride dihydrate, and 191 grams of alpha-1,3-glucan polymer with a d50 of 20 microns. The contents were heated to 56.7° C. over a period of 74 minutes. The contents were held under agitation for 14 hours at 53° C. Water and DMAc were then taken overhead under vacuum to dry the reactor contents. A total of 919 g of water and DMAc were removed. The water content of the distillate was measured by Karl-Fisher analysis to indicate 32.7 g water was removed. After cooling the contents to 55.9° C., 78 mL of phenylisocyanate were added. A 2° C. exotherm was observed. The contents were held at 58° C. for 30.5 minutes. Heat to the reactor was turned off and vacuum was pulled to cool the contents. After removing 113 g of DMAc overhead, the reactor pressure was raised back to atmospheric pressure and 1999 g of the viscous contents were poured into 6 liters of agitated water, forming white strands. The product was washed in 3 liters of methanol. After drying the product overnight under vacuum at 65° C., the product was ground to pass through a 20 mesh screen, washed 2 times with 0.75 liters methanol, and then dried overnight under vacuum at 65° C.

The overall mass balance for the reaction indicated a loss of 1.31% of the contents. The liquor at the end of the reaction contained 11.0% product. The reduced viscosity of the product was 2.62 dL/g, corresponding to a DPw of 1130. NMR analysis of the product indicated a phenyl carbamate content of 0.38 out of a possible 3.0. A 10% solution of the product in dimethylformamide was colorless viscous fluid with swelled gels.

### Example 5

To an agitated and jacketed 1 liter resin kettle equipped with an FTIR probe were added 420 g of dimethylacetamide, 15.6 g calcium chloride dihydrate, and 30 grams of alpha-1,3-glucan polymer with a d50 of 20 microns. The contents were heated to 74° C. over a period of 71 minutes to yield a clear solution. Water and DMAc were taken overhead under vacuum to dry the reactor contents; a total of 144 g of water and DMAc were removed. The water content of the distillate was measured by Karl-Fisher analysis to indicate 3.29 g water was removed. To reduce the viscosity of the mixture, 100 ml of DMAc was added. After cooling the contents to 60° C., 66 mL of phenylisocyanate were added. A 6° C. exotherm was observed. The contents were held at 61° C. for 4 hours and 45 minutes. The FTIR profiles were unchanged for an extended time to indicate reaction had reached completion. Heat to the reactor was turned off and vacuum was pulled to cool the contents. After removing 26 g of DMAc overhead, the reactor pressure was raised back to atmospheric pressure and 431 g of the viscous contents were poured into 1.5 liters of agitated methanol, forming a white rubbery ball. The wet solids were placed in 0.75 liters of 2-propanol. This hardened the product. It was then soaked in a liter of methanol. After filtering off the methanol, the solids were torn into small pieces and then dried overnight under vacuum at 65 C. It was then ground to pass a 20 mesh screen, washed twice with 0.5 liters methanol, and then dried in the same manner.

The overall mass balance for the reaction indicated a loss of 2.86% of the contents. The liquor at the end of the reaction contained 15.2% product. The reduced viscosity of the product was 1.91 dL/g, corresponding to a DPw of 747. NMR analysis of the product indicated a phenyl carbamate content of 1.96 out of a possible 3.0. A 10% solution of the product in dimethylformamide was colorless viscous fluid.

### Example 6

To an agitated and jacketed 3 liter resin kettle were added 2666 g of dimethylacetamide, 111 g of calcium chloride dihydrate, and 191 grams of alpha-1,3-glucan polymer with a d50 of 20 microns. The contents were heated to 37° C. over a period of 120 minutes to attain a clear solution. The contents were held under agitation for 12 hours and 52 minutes at 39° C. Water and DMAc were taken overhead under vacuum to dry the reactor contents; a total of 904 g of water and DMAc were removed. The water content of the distillate was measured by Karl-Fisher analysis to indicate 27.9 g water was removed. After cooling the contents to 57.6° C., 125 mL of phenylisocyanate were added. An 8° C. exotherm was observed. The contents were held at 60° C. for 33.5 minutes. Heat to the reactor was turned off and vacuum was pulled to cool the contents. After removing 87 g of DMAc overhead, the reactor pressure was raised back to atmospheric pressure and 2050 g of the viscous contents were poured into 6 liters of agitated water, forming white strands. The product was washed in 2 liters of methanol. After drying the product overnight under vacuum at 65° C., the product was ground to pass through a 20 mesh screen, washed 2 times with 1.0 liter methanol, and then dried overnight under vacuum at 65° C.

The overall mass balance for the reaction indicated a loss of 1.29% of the contents. The liquor at the end of the reaction contained 11.8% product. The reduced viscosity of the product was 2.29 dL/g, corresponding to a DPw of 960. NMR analysis of the product indicated a phenyl carbamate content of 0.70 out of a possible 3.0. A 10% solution of the product in dimethylformamide was colorless viscous fluid.

### Example 7

To an agitated and jacketed 1 liter resin kettle equipped with an FTIR probe were added 420 g of dimethylacetamide, 15.6 g calcium chloride dihydrate, and 30 grams of alpha-1,3-glucan polymer with a d50 of 20 microns. The contents were heated to 73° C. over a period of 45 minutes to attain a clear solution. Water and DMAc were taken overhead under vacuum to dry the reactor contents; a total of 144 g of water and DMAc were removed. The water content of the distillate was measured by Karl-Fisher analysis to indicate 3.92 g water was removed. To reduce the viscosity of the mixture, 100 mL of DMAc was added. After cooling the contents to 63° C., 7.5 mL of phenylisocyanate were added. A 5° C. exotherm was observed. The contents were held at 60° C. for 3 hours. The FTIR profiles were unchanged for an extended time to indicate the reaction had reached completion. Heat to the reactor was turned off and vacuum was pulled to cool the contents. After removing 37 g of DMAc overhead, the reactor pressure was raised back to atmospheric pressure and 361 g of the viscous contents were poured into 2 liters of agitated water, forming white rubbery strands. The wet strands were soaked in and filtered from 1 liter of methanol. The strands were dried overnight under vacuum at 65° C. It was then ground to pass a 20 mesh screen, washed twice with 0.2 li methanol, and then dried in the same manner.

The overall mass balance for the reaction indicated a loss of 4.25% of the contents. The liquor at the end of the reaction contained 10.4% product. The reduced viscosity of the product was 2.59 dL/g, corresponding to a DPw of 1124. NMR analysis of the product indicated a phenyl carbamate content of 0.27 out of a possible 3.0. A 10% solution of the product in dimethylformamide formed colorless swelled gels.

1-15. (canceled)

16. A composition comprising a polysaccharide derivative that comprises a polysaccharide substituted with at least one carbamate group,
wherein the polysaccharide comprises poly alpha-1,3-glucan or poly alpha-1,3-1,6-glucan, and the polysaccharide derivative has a degree of substitution of about 0.001 to about 3.0,
wherein the composition is a fabric care composition or a dishwashing detergent composition.

17. The composition of claim 16, wherein the polysaccharide comprises said poly alpha-1,3-glucan, and at least 50% of the glycosidic linkages of the poly alpha-1,3-glucan are alpha-1,3 linkages.

18. The composition of claim 16, wherein the polysaccharide comprises said poly alpha-1,3-glucan, and at least 90% of the glycosidic linkages of the poly alpha-1,3-glucan are alpha-1,3 linkages.

19. The composition of claim 16, wherein the polysaccharide comprises said poly alpha-1,3-1,6-glucan, wherein (i) at least 30% of the glycosidic linkages of the poly alpha-1,3-1,6-glucan are alpha-1,3 linkages, (ii) at least 30% of the glycosidic linkages of the poly alpha-1,3-1,6-glucan are alpha-1,6 linkages, (iii) the poly alpha-1,3-1,6-glucan has a weight-average degree of polymerization of at least 10, and (iv) the alpha-1,3 linkages and alpha-1,6 linkages of the poly alpha-1,3-1,6-glucan do not consecutively alternate with each other.

20. The composition of claim 16, wherein the polysaccharide derivative has a weight-average degree of polymerization of about 5 to about 1400.

21. The composition of claim 16, wherein the at least one carbamate group is derived from an aliphatic, cycloaliphatic, or aromatic monoisocyanate.

22. The composition of claim 16, wherein the at least one carbamate group is a phenyl carbamate group.

23. The composition of claim 16, wherein the composition is said fabric care composition.

24. The composition of claim 23, wherein the composition the fabric care composition is a laundry detergent composition.

25. The composition of claim 16, wherein the composition is said dishwashing detergent composition.

26. The composition of claim 25, wherein the dishwashing detergent composition is an automatic dishwashing detergent composition.

27. The composition of claim 16, wherein the composition further comprises at least one surfactant.

28. The composition of claim 16, wherein the composition further comprises at least one enzyme.

29. The composition of claim 28, wherein the enzyme is a protease, cellulase, hemicellulase, peroxidase, lipolytic enzyme, xylanase, phospholipase, perhydrolase, cutinase, pectinase, pectate lyase, mannanase, keratinase, reductase, oxidase, phenoloxidase, lipoxygenase, ligninase, pullulanase, tannase, pentosanase, malanase, beta-glucanase, arabinosidase, hyaluronidase, chondroitinase, laccase, metalloproteinase, amadoriase, glucoamylase, arabinofuranosidase, phytase, isomerase, transferase, nuclease, or amylase.

30. The composition of claim 16, wherein the composition further comprises at least one detergent builder, complexing agent, soil release polymer, surfactancy-boosting polymer, bleaching agent, bleach activator, bleach catalyst, fabric conditioner, clay, foam booster, suds suppressor, anti-corrosion agent, soil-suspending agent, anti-soil redeposition agent, dye, bactericide, tarnish inhibitor, optical brightener, perfume, saturated or unsaturated fatty acid, dye transfer inhibiting agent, chelating agent, hueing dye, calcium cation, magnesium cation, visual signaling ingredient, anti-foam, structurant, anti-caking agent, starch, sand, or gelling agent.

31. The composition of claim 16, wherein the composition is in the form of a unit dose.

32. The composition of claim 16, wherein the composition is in the form of a liquid, gel, hydrocolloid, or aqueous solution.

33. The composition of claim 16, wherein the composition is in the form of a powder, granule, microcapsule, flake, particulate matter, pellet, bar, kernel, bead, tablet, stick, capsule, single compartment sachet, multi-compartment sachet, single compartment pouch, multi-compartment pouch, pad, or sponge.

34. The composition of claim 16, wherein the composition is in the form of a foam or non-woven.

35. The composition of claim 16, wherein the composition is in the form of a film or coating.
